(19) United States
(12) Patent Application Publication
(10) Pub. No.: US 2025/0103195 A1
(43) Pub. Date: Mar. 27, 2025

(54) FACILITATING EXTENDED REALITY TARGET SELECTION BY BLENDING GAZE AND CONTROLLER RAYCASTING, AND SYSTEMS AND METHODS OF USE THEREOF

(71) Applicant: Meta Platforms Technologies, LLC, Menlo Park, CA (US)

(72) Inventors: Stephanie Santosa, Toronto (CA); Hrvoje Benko, Seattle (CA); Tovi Grossman, Ontario (CA); Marcello Giordano, Toronto (CA); Di Chen, Toronto (CA)

(21) Appl. No.: 18/893,859

(22) Filed: Sep. 23, 2024

Related U.S. Application Data
(60) Provisional application No. 63/584,861, filed on Sep. 22, 2023.

(51) Int. Cl. G06F 3/04842; G06F 3/01; G06F 3/0346; G06F 3/04815

(52) U.S. Cl. CPC G06F 3/04842; G06F 3/013; G06F 3/0346; G06F 3/04815

(57) ABSTRACT

An electronic device for target object selection in extended-reality environments is disclosed. While an extended-reality user interface, including a plurality of virtual objects, is being presented to a user by the electronic device, the electronic device: receives first data for a gaze-based selection ray that intersects with a first set of two or more candidate objects of the plurality of virtual objects; receives second data for a controller-based selection ray that intersects with a second set of two or more candidate objects of the plurality of virtual objects; determines, based on the first data and the second data, an intersection point between the gaze-based selection ray and the controller-based selection ray; and based on the intersection point, identifies a desired candidate object from the first set of two or more candidate objects or the second set of two or more candidate objects.

### RELATED APPLICATIONS

This application claims the benefit of, and priority to, U.S. Provisional Patent Application Ser. No. 63/584,861, filed on Sep. 22, 2023, which is incorporated by reference herein in its entirety.

### TECHNICAL FIELD

This relates generally to object selection in extended-reality (XR) environments (e.g., objects presented within mixed, virtual, or augmented reality user interfaces) including but not limited to techniques for blending gaze and controller raycasting for object selection, and providing enhanced object facilitation for improved object selection accuracy.

### BACKGROUND

Object selection is an essential interaction in extended-reality (XR) (e.g., 3D virtual reality (VR), artificial-reality (AR), mixed-reality (MR)) environments. Controller raycasting with a visible ray cursor that moves along a controller ray, highlighting the closet object to the cursor, is one technique for pointing and selection tasks in such environments. However, the selection of objects via controller raycasting results in selection ambiguity when the target object is located in a densely packed environment with other objects that are located at varying depths along a controller ray causing the controller ray to intersect with multiple potential candidate objects. In instances of the controller ray intersecting with multiple objects, the controller raycasting approach highlights the object closest to the user which is often not the desired target object.

Some disambiguation techniques that assist with the controller raycasting-based selection require the use of a manual mode to adjust the depth of a region of interest along the controller ray or require a user to first select a general area and then identify the target of interest within this area through additional user input mechanisms. These approaches introduce extra manual refinement steps to the disambiguation process based on extra user inputs, thereby leading to user frustration with the additional time and complexities needed for the disambiguation processes. Target object selection is then no longer an automatic process and instead, becomes a cumbersome series of selection steps by manipulating the displayed cursor via an input mechanism (e.g., using a touchpad feature) of the handheld controller device.

Additionally, in some instances, the usability of the manual mode is limited due to eye-hand visibility mismatches. For example, the manual mode necessitates the user to manipulate a slider on a mobile phone, or a touchpad on an XR controller to adjust the depth of the ray to select a target. However, eye-hand visibility mismatch arises in some situations where objects that are visible from the user's eye position are occluded from the user's hand position, and objects that are selectable from the hand position appear occluded from the eye position. This adversely effects the target selection accuracy and time, and negatively impacts the user's experience with the XR system.

Some object depth estimation models that are used to assist with target object selection include vergence-based and pupil center distance-based models. Vergence-based target object depth estimation is based on tracking the simultaneous turning motions of a user's eyeballs towards or away from each to calculate a target object's depth. Vergence-based target object depth estimation relies on crossing the gaze rays from both eyes of the user and using the intersection to determine a 3D target gaze position. Tracking pupil center distance between the eyes of the user can also be used to determine the target object depth. However, vergence-based and pupil center distance-based techniques require substantial effort for determining the gaze convergence point because the left and right gaze vectors can be close to parallel, thereby reducing the effectiveness and accuracy of these models.

As such, there is a need to address one or more of the above-identified challenges. A brief summary of solutions to the issues noted above is described below.

### SUMMARY

The methods and systems disclosed herein describe a blended object selection technique for extended-reality (XR) environments using both controller raycasting and eye-gaze raycasting. When selecting an object in XR environments, controller based raycasting often results in ambiguities in object selection in crowded target environments. To resolve the target selection ambiguities encountered during controller raycasting, described herein are systems and methods that enhance controller raycasting with gaze-based raycasting to provide blended gaze and controller ray casting for target object selection. In some embodiments, the blended gaze and controller ray casting estimates target object depth by projecting the closest intersection between gaze-rays and controller-rays onto the controller ray. An XR display of an object that is closest to the estimated intersection is automatically highlighted by the XR system, without display of and/or user interaction with a cursor (e.g., controller-raycasting cursor, object selection cursor, etc.), indicating to the user that the highlighted object is the currently selected object. The user can provide a user input indicative of an acceptance of the highlighted object as the desired target object for selection. In some embodiments, the systems and methods use combined gaze-rays respectively associated with each eye (e.g., left eye and right eye) along with the controller-ray for faster, more responsive, and accurate target selection even in crowded XR environments. For example, the gaze-based selection ray is a combined selection ray that is based on first gaze of a first eye of the user and second gaze of a second eye of the user.

In some embodiments, the blended gaze and controller ray casting technique disclosed herein enables the gaze-rays and controller-rays to complement each other to eliminate the need for a manual mode adjustment of object depth. This in turn avoids any eye-hand visibility mismatch issues that can arise during a manual mode adjustment of object depth. Additionally, the gaze-rays are configured to function as an implicit modality, without a need for display and/or user manipulation of a cursor (e.g., object selection cursor).

(A1) In accordance with some embodiments, an electronic device is disclosed. The electronic device includes one or more programs, wherein the one or more programs are stored in memory and configured to be executed by one or more processors. The one or more programs include instructions for while an extended-reality user interface is being presented to a user, the extended-reality user interface includes a plurality of virtual objects available for selection including: (i) receiving first data indicating a gaze-based selection ray based on an eye gaze of the user, wherein the gaze-based selection ray intersects a first set of two or more candidate objects of the plurality of virtual objects, (ii) receiving second data indicating a controller-based selection ray based on position and orientation of an input controller used by the user to interact with the extended-reality user interface, wherein the controller-based selection ray intersects a second set of two or more candidate objects of the plurality of virtual objects, (iii) determining, based on the first data and the second data, an intersection point between the gaze-based selection ray and the controller-based selection ray, (iv) based on the intersection point, identifying a desired candidate object from the first set of two or more candidate objects or the second set of two or more candidate objects, and (v) causing a selection of the candidate object. As shown in FIG. 8A, the lighter shaded object that is the closest to the intersection point is determined to be the desired candidate object and not the darker shaded object.

(A2) In some embodiments of A1, the gaze-based selection ray is a combined selection ray that is based on first gaze of a first eye of the user and second gaze of a second eye of the user. As shown in FIG. 4C, the combination of using the gaze-rays for both eyes increases the accuracy for identifying and selecting the desired object when combined with the controller-ray.

(A3) In some embodiments of A1-A2, identifying the desired candidate object from the first set of two or more candidate objects or the second set of two or more candidate objects occurs without display of an object selection cursor. As shown in FIGS. 1, 2D, 4C, 8A, and 8B, and their accompanying descriptions, the blended gaze and controller raycasting system does not display a cursor for object selection.

(A4) In some embodiments of A1-A3, each object of the plurality of objects is presented with the extended-reality user interface at a respective depth relative to the user, and the desired candidate object is at a greater depth than at least one candidate object of the first set of two or more candidate objects. As shown in FIG. 2A-2D, a plurality of objects is shown at different depths, and the intersected object (e.g., the desired object) shown in FIG. 2D is at a greater depth than another larger object (e.g., the large dark solid color sphere).

(A5) In some embodiments of A1-A4, the desired candidate object is at a greater depth than at least one candidate object of the second set of two or more candidate objects.

(A6) In some embodiments of A1, the electronic device is a head-mounted device configured to present the extended-reality user interface to the user. As shown in FIGS. 11C-1-11C-2, the user is able to see one or more virtual reality objects on the display of the head-mounted device.

(A7) In some embodiments of A1-A2, the electronic device is an intermediary device. For example, as illustrated in FIG. 11A, the intermediary device could be a computer, smartphone, a wrist-wearable device, etc.

(B1) In some embodiments, a non-transitory computer readable storage medium including instructions that, when executed by an electronic device (e.g., head-mounted device or intermediary device), cause the electronic device to perform or cause performance of the operations recited for the electronic device in any of A1-A7. Examples of the non-transitory computer readable storage medium are shown in FIGS. 11A-14B.

(C1) A method, comprising operations in accordance with the operations recited in any of A1-A7. Operations of the electronic device are discussed in reference to FIGS. 11A-14B.

(D1) A system that includes one or more input devices (e.g., controllers and/or wrist wearable devices) and an extended-reality headset, and the extended-reality headset is configured to perform operations corresponding to those operations recited in any of A1-A7. For example, one or more input devices are shown in FIGS. 11A-14B.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 shows an example illustration of a combined gaze and controller raycasting system, in accordance with some embodiments.

FIGS. 2A-2D show example illustrations of gaze-ray and/or controller-ray based object selection methods, in accordance with some embodiments.

FIG. 3A shows an example illustration for estimating object size based on an angular diameter of the object from a head-mounted display (HMD), in accordance with some embodiments.

FIG. 3B shows an example illustration for determining an object position based on x- and y-direction angles from the HMD, in accordance with some embodiments.

FIGS. 4A-4D show example illustrations of depth estimation techniques based on controller raycasting combined with different modalities of gaze raycasting, in accordance with some embodiments.

FIGS. 5A and 5B show an example of mean depth estimation percentage error for each of the gaze and controller depth estimation techniques discussed herein, in accordance with some embodiments.

FIG. 6 shows a table showing example effect of angles in the x- and y-direction on mean absolute error for a combined gaze and controller raycasting system, in accordance with some embodiments.

FIGS. 7A and 7B show an example graph of mean angles between the combined gaze ray and controller ray and the mean error directions, in accordance with some embodiments.

FIGS. 8A-8D illustrate an example of one of more selection techniques used to select a desired object, in accordance with some embodiments.

FIGS. 9A and 9B are bar charts showing the mean task completion time (TCT) and the mean selection error for multiple depth estimation techniques discussed herein, in accordance with some embodiments.

FIG. 10 illustrates a flowchart for an example blended gaze and controller raycasting system, in accordance with some embodiments.

FIGS. 11A, 11B, 11C-1, and 11C-2 illustrate example extended-reality systems, in accordance with some embodiments.

FIGS. 12A and 12B illustrate an example wrist-wearable device 1100, in accordance with some embodiments.

FIGS. 13A, 13B-1, 13B-2, and 13C illustrate example head-wearable devices, in accordance with some embodiments.

FIGS. 14A-14B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

The methods and devices described herein include methods and systems for using a gaze ray produced based on averaging left and right gaze rays (e.g., one gaze ray associated with a user's left eye and another gaze gay associated with a user's right eye) together with a controller ray (e.g., a left controller ray and/or a right controller ray) to thereby achieve significantly less depth estimation effort as compared to using convergence of the left and right gaze rays alone. In some embodiments, a controller ray includes projections based on hand position while the user is not holding a controller.

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

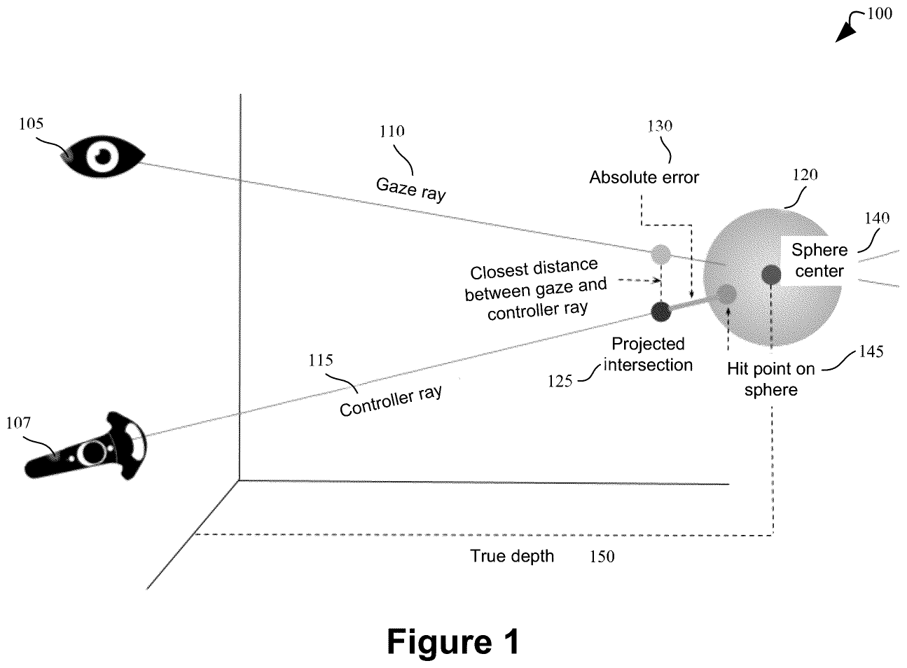

FIG. 1 is an example illustration of the blended gaze and controller raycasting system, in accordance with some embodiments. In some embodiments, the system uses eye gaze-rays and controller-rays to estimate the depth of objects in extended-reality environments (e.g., AR or VR environments, with VR environments used as the primary embodiment here, but the techniques are applicable to many types of extended-reality environments as well) and resolve ambiguity during target selection. In some embodiments, a user hand position and/or orientation, without a controller, can be used such that hand-rays are combined with gaze-rays in place of the controller-rays. In some embodiments, a wrist-wearable device can also be used in conjunction with eye gaze or a controller to estimate the depth objects in extended-reality (such as by using position and/or orientation data from sensors of the wrist-wearable device, e.g., from an inertial measurement unit, to then augment or replace the use of a controller ray to make use of a hand ray or to further refine accuracy of the controller ray with this additional data).

In some embodiments, the system uses combined information from a gaze-ray 110 and a controller-ray 115 because in extended-reality environments, a likelihood for the gaze-ray 110 and the controller-ray 115 to intersect at exactly the same point in 3D space, when targeting an object, is low. In some embodiments, the gaze-ray 110 is estimated from a determined position of the user's eye 105 and the controller-ray is estimated from a determined position of the controller device 107 (and/or hand, wrist-wearable device, etc.). In some embodiments, the system uses two forward ray vectors respectively corresponding to the gaze-ray 110 and the controller-ray 115 to determine an estimated point of intersection by projecting a point of the gaze-ray 110 onto the controller-ray 115. The point of projection is the projected intersection 125. In some embodiments, the projected intersection 125 is a point on the controller-ray 115 that is closest to the gaze-ray 110 when both rays are targeting the same object. For example, the projected intersection 125 can be found by calculating the shortest line that connects the two rays. In some embodiments, the projection is done on the controller-ray 115 rather than the gaze-ray 110 because the user can manipulate the controller-ray with greater precision. The projected intersection 125 is used to measure the accuracy of an object's estimated depth by comparing the distance between the projected intersection and an actual depth of a surface of the object (e.g., target sphere 120), and determining an absolute error 130 value. In some embodiments, the absolute error is estimated based on a difference between the projected intersection 125 and a hit point 145 on the surface of the object. In some embodiments, the true depth 150 of the object is the distance between the controller and the object center (e.g., sphere center 140).

In some embodiments, the blended gaze and controller raycasting system does not explicitly show a gaze cursor to the user, and gaze is not used for target pre-selection. Rather, gaze functions as an implicit modality that complements controller-ray based object selection (and/or hand position and orientation-based selection), without the need for a cursor, and assists in target disambiguation. The blended gaze and controller raycasting system leverages both gaze-rays and controller-rays in object selection and manipulation, to reduce physical effort and achieve greater accuracy, naturalness, and speed compared to using an individual selection modality. Additionally, the blended gaze and controller raycasting system offers a viable and improved method for target disambiguation during selection of virtual objects in extended-reality environments, without introducing new explicit input modalities or additional target selection refinement steps.

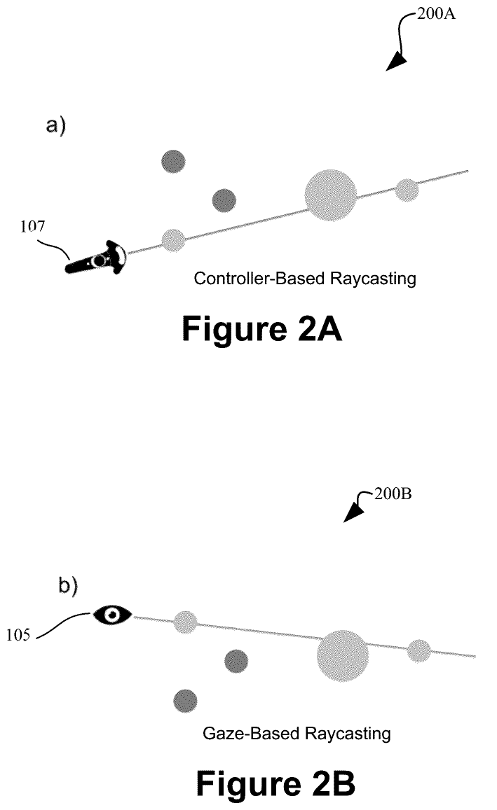

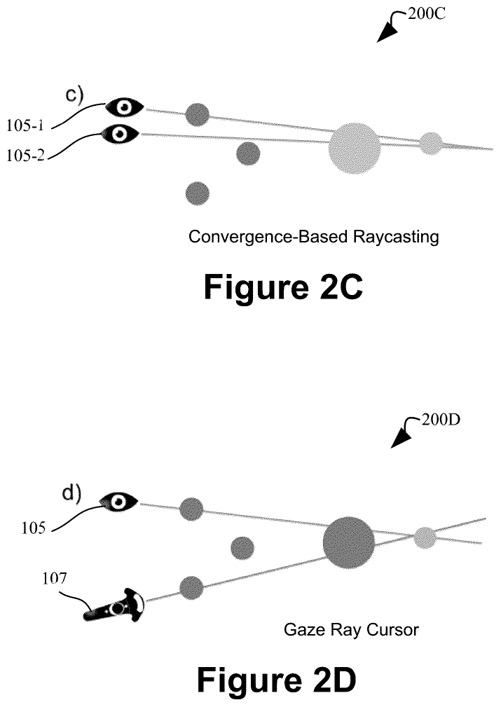

FIGS. 2A-2D illustrate different gaze-ray and/or controller-ray based object selection methods, in accordance with some embodiments. In some embodiments, objects in the extended-reality environment are displayed in a solid dark color as a default display color. In some embodiments, objects in the extended-reality environment are displayed in lighter, transparent, and/or translucent colors after they are highlighted for potential selection. For example, an object will change from a dark solid color to a lighter and/or translucent color upon being highlighted and/or chosen for selection by a user. After a highlighted object has been confirmed to be desired target object by the user, the display color of the object will change. For example, confirmation of a highlighted object as the desired target object will change the object display color from the lighter and/or translucent color to a bright green color.

FIG. 2A shows an example illustration of the controller raycasting method, in accordance with some embodiments. The stand-alone controller raycasting method performs object selection using only a controller ray. The raycasting is based on controller 107 orientation and direction, and results in object selection ambiguity in crowded environments when the controller ray intersects (passes through) multiple objects (as shown by the multiple objects in the lighter color in FIG. 2A).

FIG. 2B shows an example illustration of a gaze-based raycasting method, in accordance with some embodiments. The gaze-based raycasting method performs object selection using only a gaze ray. The raycasting is based on a gaze ray from one of the user's eyes 105 and depends on gaze direction. The gaze-based raycasting can cause object-selection ambiguity at various depths when the gaze ray intersects (passes through) multiple objects (as shown by the multiple objects in the lighter color in FIG. 2B).

FIG. 2C shows an example illustration of the convergence-based raycasting method, in accordance with some embodiments. The convergence-based raycasting uses the convergence of the gaze rays from each eye (e.g., 105-1, 105-2) of the user to help resolve object selection ambiguity in crowded environments. However, convergence-based raycasting is prone to object selection ambiguities in crowded extended-reality applications.

FIG. 2D shows an example illustration of the blended gaze ray and controller raycasting method, in accordance with some embodiments. The blended gaze ray and controller raycasting method is based on a combination of gaze rays and controllers ray or rays. The method uses the intersection of the gaze and controller rays to disambiguate object selection, since the angle between the rays is sufficiently large such that ambiguity in object selection can be reduced significantly and often eliminated. In some embodiments, the blended gaze and controller ray casting combines the controller ray and gaze ray, and projects the closest intersection point between these rays onto to infer the depth of an object. As the controller ray and gaze ray are much farther apart, there is a larger angle from which to calculate an intersection point.

A first study compared the use of different subsets of the controller ray, left eye gaze-ray, and right eye gaze-ray to estimate the depth of XR objects. In some embodiments, the first study demonstrated that using a combined gaze-ray produced from the average of the left and right gaze-rays, together with the controller ray, achieved significantly less depth estimation error than using the convergence of the left and right gaze rays.

The purpose of this first study was to explore different fusions of gaze and controller rays that could be used to infer object depth in XR to determine optimized blended gaze and controller raycasting systems and methods. Four methods for object depth estimation using different combinations of gaze-rays and controller-rays are evaluated including left gaze-ray and controller ray (LGC), right gaze-ray and controller-ray (RGC), combined left and right gaze-rays and controller-rays (CGC), and convergence gaze-rays and controller-rays (ConvGC).

Twelve participants were recruited (10 male, 2 female; μ=33 years, range=18 to 54 years,) with normal or corrected-to-normal vision. All participants were right-handed. Participants were asked to perform a dominant eye test before the study, and eleven participants had the right eye as their dominant eye. When asked how they would describe themselves as a VR user, 7 participants indicated they were beginners, 3 were intermediate, and 2 were experts.

The first study was conducted using an extended-reality system that included a head-mounted display (HMD) in communication with a controller for user input. In some embodiments, the HMD has a 110-degree field of view (FOV), a refresh rate of 90 Hz, and a resolution of 1440×1600 pixels per eye. In some embodiments, the gaze data was output from the virtual-reality system's eye tracking at 120 GHz. The study consisted of a pointing task in XR. During each trial, a white target sphere was rendered in the XR environment. The sphere was rendered at a different target depth, size, and angle during each trial. The participant's task was to select the target by pointing the controller ray at the target while focusing their gaze directly on or near the sphere. The target became highlighted in yellow and selectable only when the controller ray passed through it and the eye gaze ray fell within a gaze focus boundary around the sphere. In some embodiments, the gaze focus boundary was 1.8 times the radius of the sphere to allow for some inaccuracy in the gaze direction. The controller ray and gaze ray had to be directed at the target for a minimum duration of time (e.g., at least 0.1 seconds, 0.3 seconds, 0.4 seconds, etc.) before the target became selectable to prevent the participant clicking at random. When the target became highlighted, the participant selected it by clicking on the controller's trigger button.

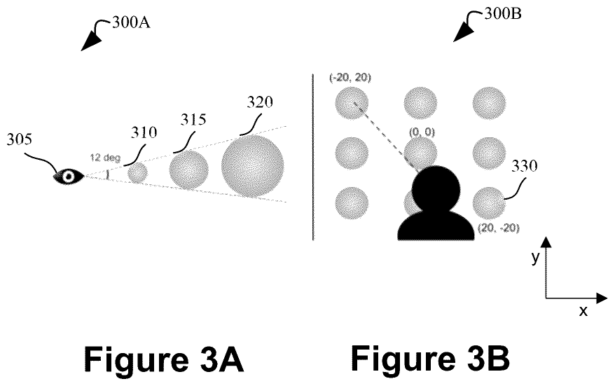

In some embodiments, the study used a repeated-measures, within-subject design. The position of the target sphere in each trial varied based on 3 independent variables—true depth, size, and angle. True depth was the distance between the origin to the sphere center along the z-axis. 25 depths were used, ranging from 0.5 meters to 50 meters (e.g., 0.5, 1, 1.5, 2, 2.5, 3, 3.5, 4, 4.5, 5, 5.5, 6, 6.5, 7, 7.5, 8, 8.5, 9, 9.5, 10, 15, 20, 25, 30, 50). The true depth is distinct from the estimated depth. In some embodiments, object size and/or position was determined using the angular diameter of the sphere with respect to the HMD as described in FIGS. 3A and 3B below.

FIG. 3A shows an example illustration for estimating object size based on an angular diameter of the object from a HMD, in accordance with some embodiments. In some embodiments, the angle is the angle between the HMD's forward vector and the object's center. The angular diameter respectively associated with each object is a metric by which to estimate how large an object (e.g., sphere 310, sphere 315, sphere 320, etc.) would appear from the HMD's position (e.g., point-of-view of HMD 305, etc.). For a single angular diameter (e.g., 12 degrees), the farther the object, the larger the object's size. However, the object would appear in the HMD as the same size event at different depths. In some embodiments, different angular diameters were evaluated corresponding to different angles between the HMD's forward vector and each object's center (e.g., 4, 8, and 12 degrees).

FIG. 3B shows an example illustration for determining an object position based on x-direction and y-direction angles from the HMD, in accordance with some embodiments. In some embodiments, an object sphere was placed at three angles (e.g., −20, 0, 20 degrees) in each of the x-directions and y-directions, for a total of nine positions. For example, sphere 330 is placed at 20 degrees in the x-direction and −20 degrees in the y-direction.

The presentation order of the true depths, sizes, and angles of the objects was randomized but no two consecutive trials had an object sphere appearing at the same angle. Each target true depth, size, and angle appeared in the study two times, resulting in a total of 1350 trials per participant (i.e., 25×3×9×2=1350 trials).

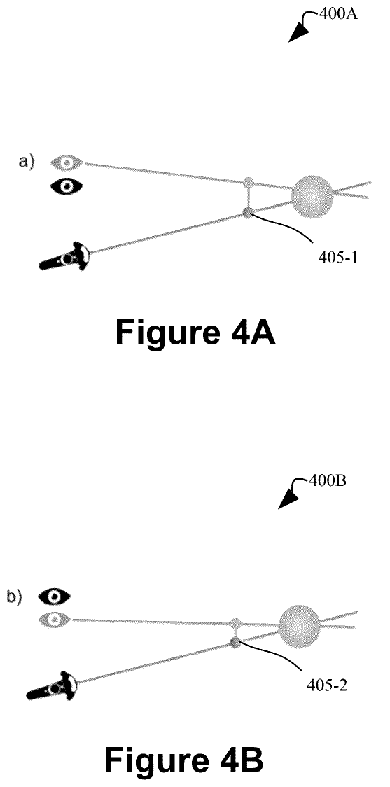

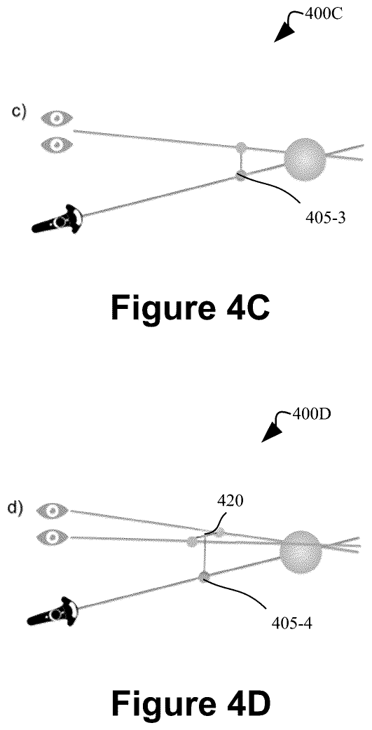

Four depth estimation techniques that combined subsets of the left gaze ray, the right gaze ray, and the controller ray were analyzed and evaluated as described with respect to FIGS. 4A-4D below.

FIGS. 4A-4D show example illustrations of depth estimation techniques based on controller raycasting combined with different modalities of gaze raycasting, in accordance with some embodiments. The solid dark dot (e.g., 405-1, 405-2, 405-3, 405-4) in each of these figures represents the projected intersection of a closest point of a corresponding gaze ray on the controller ray.

FIG. 4A illustrates a Left Gaze and Controller (LGC) system, in accordance with some embodiments. The LGC system calculates the projected intersection 405-1 of the left eye gaze-ray on the controller-ray.

FIG. 4B illustrates a Right Gaze and Controller (RGC) system, in accordance with some embodiments. The RGC system calculates the projected intersection 405-2 of the right eye gaze ray on the controller ray. The LGC and RGC methods were evaluated to determine an accuracy respectively associated with each method for calculation of true depth.

FIG. 4C illustrates a Combined Gaze and Controller (CGC) system, in accordance with some embodiments. The CGC system calculates an average of the left and right gaze-rays, combines them into a single ray originating from between the two eyes, and determines the projected intersection 405-3 of the combined gaze-ray on the controller-ray.

FIG. 4D illustrates a Convergence Gaze and Controller (ConvGC) system, in accordance with some embodiments. The ConvGC system estimates true depth using eye gaze convergence in which the convergence point 420 was first found by calculating the midpoint of the shortest line between the left gaze ray and the right gaze ray. The convergence point 420 was then projected onto the controller ray in an additional step to harmonize the controller-gaze-based methods in terms of projected intersections to enable a fair comparison and consistent error metric.

Depth estimation methods were used, as described above with respect to FIGS. 1 and 3A-4D, for each raycasting system of FIGS. 4A-4D. In some embodiments, the depth estimation techniques used the projected intersection on the controller ray. The absolute error was calculated as the distance (e.g., in meters) between the projected intersection and the controller ray hit point on the sphere (as described with respect to FIG. 1). In some embodiments, the overall mean absolute errors for the LGC, RGC, CGC, and ConvGC techniques were 5.07 meters, 5.34 meters, 5.04 meters, and 7.50 meters respectively. The CGC system demonstrated the lowest mean absolute error (CGC). In some embodiments, the CGC raycasting system provided a 32.8% improvement over the ConvGC system.

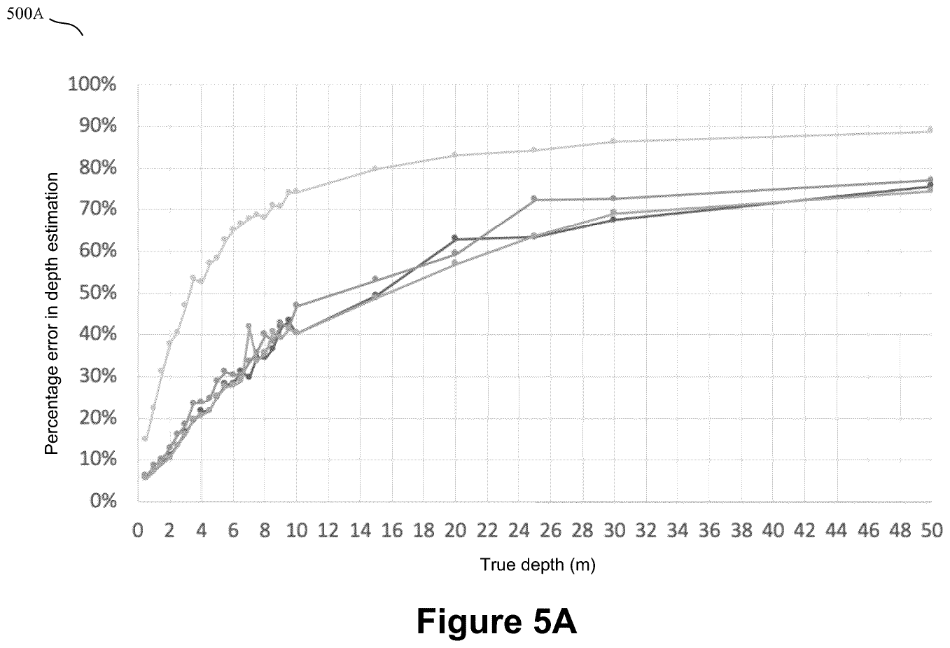

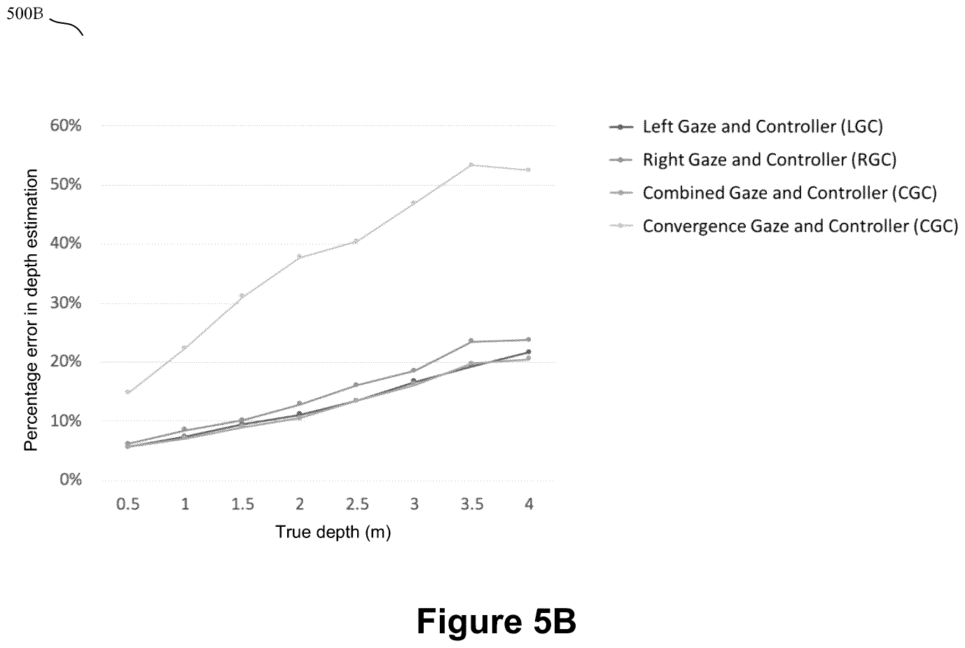

FIG. 5A shows an example illustration of variations in mean depth percentage errors for each technique versus true depth of desired target object, in accordance with some embodiments. For example, as the true depth increases, the estimated depth error also increases.

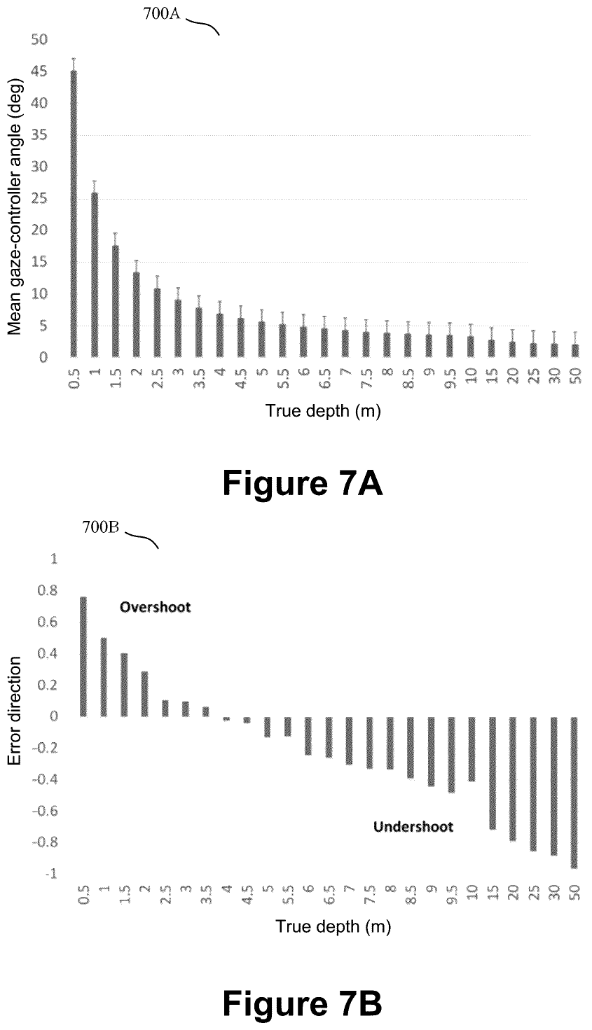

FIG. 5B shows an example illustration of variations in mean depth estimation percentage error for true depths less than or equal to 4 meters, in accordance with some embodiments. In some embodiments, the estimated depth error increases with an increase in the true depth of the target because of a decrease in an angle between the combined gaze ray and the controller ray's forward vectors as described with reference to FIG. 7A below.

The percentage error of the estimated depth from the true depth was computed to compare trends across different depths. Percentage error was calculated by dividing the depth absolute error by the true depth. The percentage error grew rapidly as the true depth increased, and true depths beyond 4 meters had more than 20% percentage error for all techniques (e.g., as illustrated in FIGS. 5A and 5B). However, the percentage errors for close objects were much lower. For example, the percentage error for CGC at 0.5 meters of true depth was 5.58%. For the first study, the CGC system achieved the lowest error among all techniques, consistently across each of the experiment independent variables.

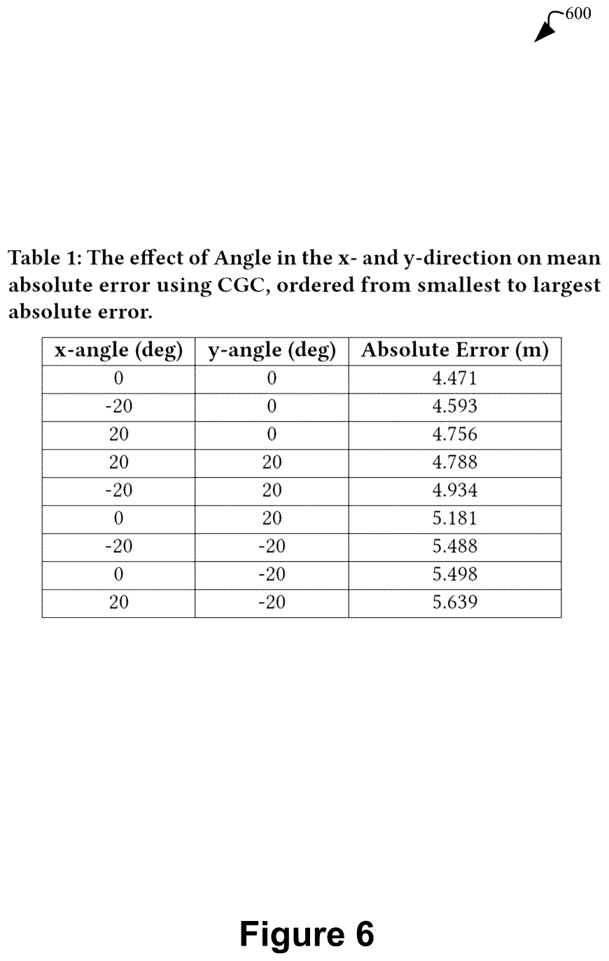

FIG. 6 shows a table for the effect of angle in the x-direction and y-direction on mean absolute error using CGC, in accordance with some embodiments. In some embodiments, as object size increase, the absolute error value increased, showing a direct correlation. For example, post-hoc tests showed that the absolute error for a sphere with angular diameter of 4° (μ=4.51 meters) was significantly lower than that of 8° (μ=5.17 meters) and 12° (μ=5.43 meters). For smaller objects (e.g., small sphere), a user's eye gaze is forced to focus over a smaller region. For example, the eye gaze focuses on a more restricted area on smaller spheres as compared to larger spheres, improving the projected intersection used to estimate depth.

In some embodiments, post-hoc tests showed that error values for objects positioned at different respective x- and y-directions (e.g., (0,0), (−20,0), (20,20), etc.) were different depending upon locations. For example, absolute error values for objects positioned at (0, 0) and (−20, 0) were significantly different than absolute error values for objects positioned at (−20, −20), (0, −20), and (20, −20). The center position from the participant's point of view, (0, 0), achieved the lowest error. The y-direction angles seemed to form a pattern, where the lowest three errors occurred when the y-angle was 0° (i.e., the target was in the middle row), and the highest three errors occurred when the y-angle was −20° (i.e., the target was at the bottom row). This may be due to eye tracking accuracy deteriorating when targets are further into the periphery. In some embodiments, the CGC systems can incorporate additional eye-tracking features to improve peripheral tracking and reducing absolute errors in object depth estimations for objects located at peripheral regions of extended-reality systems.

FIG. 7A shows an example illustration of variations in mean gaze-controller angle versus true depth of desired target object, in accordance with some embodiments. As true depth increases, the mean gaze-controller angle is seen to significantly decrease. This can be explained by looking at the gaze-controller angle, i.e. the angle between the combined gaze ray and the controller ray's forward vectors. This angle is large when the object is close, but eventually reaches a plateau when the target object is placed farther away. As a location of objects increases in true depth, the mean gaze-controller angle becomes very small. The decrease in the mean gaze-controller angle causes an increase in difficulty in depth estimations using projected intersections because a small mean gaze-controller angle would be indicative of the gaze-rays and controller-rays being almost parallel to each other.

FIG. 7B shows an example illustration of error direction versus true depth of the desired target object, in accordance with some embodiments. A positive error direction is indicative of an overshoot in the estimated target depth at a respective true depth value. A negative error direction is indicative of an undershoot in the estimated target depth at a respective true depth value. A magnitude of the overshoot error or undershoot error is a normalized metric based on an amount of estimated depth error relative to the respective true depth value. For true depths smaller than 4 meters, an overshoot error occurred more often than an undershoot error. For true depths larger than 4 meters, the opposite occurred. An undershoot error implies that for objects farther away, one's eye gaze perceived the object to be located closer (at a lower depth) than the object's true depth.

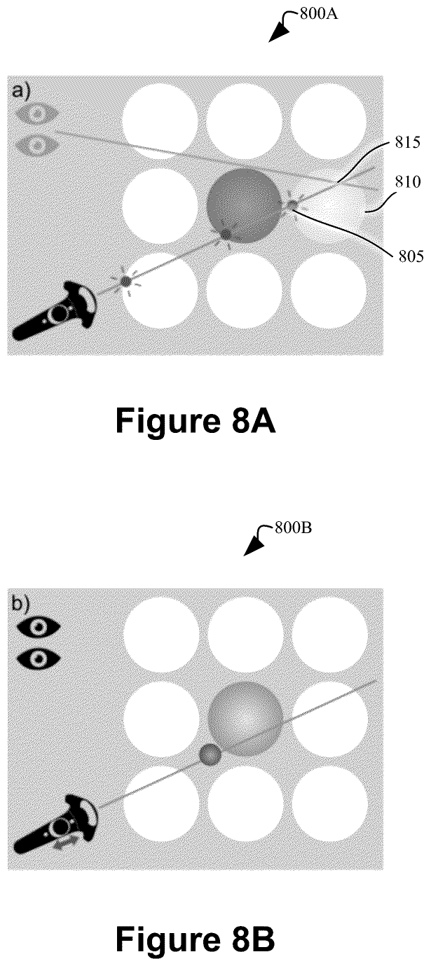

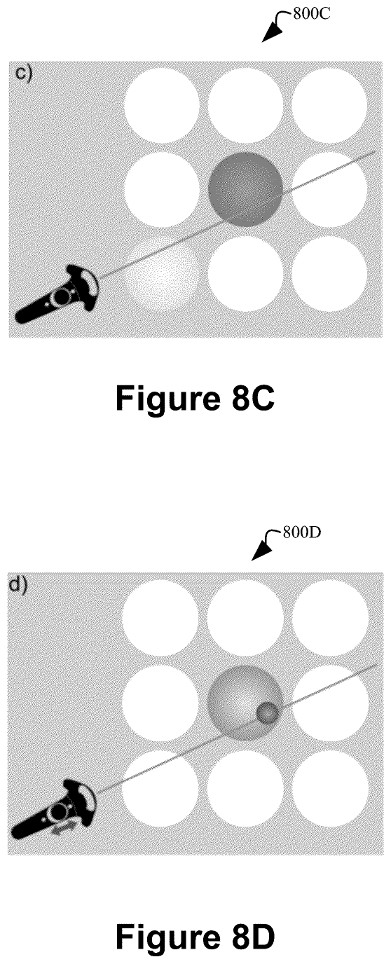

The first study described above (with respect to FIGS. 3A-7B) was conducted in a single target environment, to identify the depth estimation accuracy levels when pointing at known targets. The first study determined that the CGC system for target depth estimation performed better than stand-alone eye convergence. For example, in the first study, CGC was determined to provide the most accurate estimates of target object depth. However, integration of the CGC system into an optimized target selection and facilitation system required further analysis and optimization. A second study described below with respect to FIGS. 8A-8D evaluated and optimized two variations of the CGC system, and compared to the two variations with the stand-alone controller-ray casting method. The two variations of the CGC system are automatic blended gaze and controller ray casting (auto-CGC) and semi-automatic blended gaze and controller ray casting (semi-CGC).

FIGS. 8A-8D show example illustrations of object selection methods in dense environments for a second user study, in accordance with some embodiments. FIG. 8A illustrates an example of auto-CGC that calculates the projected intersection of the combined gaze-rays and controller-ray, and highlights the closest object to the projected intersection point (as described with respect to FIG. 4C). In some embodiments, the auto-CGC automatically highlights the object 810 whose hit point is closest to the projected intersection point 815 although the controller ray intersects multiple other objects in the environment. In some embodiments, an accuracy of the auto-CGC system can be adversely affected by an increase in object size because there is a less focused region to gaze upon. For example, an increase in object gaze area correlates with an increased discrepancy between the estimated object depth and the true depth of the object. To minimize gaze discrepancy effects, for each hit point on an intersected object, the system can cause display of a 3-centimeter colored gaze focus circle 805 to flash at a certain minimum frequency (e.g., 10 Hz, 16 Hz, 25 Hz, etc.). In some embodiments, the color (e.g., green, blue, red, etc.) and/or frequency of display of the gaze focus circle is selected to be comfortably perceivable to human eyes. The gaze focus circle 805 shown at the hit points causes the user to focus gaze on the object as indicated by the gaze focus circle 805 and generate more accurate projected intersections.

FIG. 8B illustrates an example of the semi-CGC which provides CGC with an additional manual mode. In some embodiments, the manual mode provides the user with greater control for adjusting a depth of object selection after a projected intersection point has been identified using the combined gaze-rays and controller raycasting method. In some embodiments, the semi-CGC can be activated by the user if the object highlighted by the auto-CGC is not the desired target object. In some embodiments, the manual mode can enable the user to snap from a first selected object to a second object located in proximity to the first object but at a different depth along the vector direction of the controller ray. When snapping from the first object to the second object, the semi-CGC system can cause the highlighting to shift from the first object to the second object. In some embodiments, the manual mode for the semi-CGC system enables desired object selection, along the controller ray, by analyzing manual controller adjustments made by the user to adjust selection depth. The manual controller adjustments can be made by the user's thumb swipes on the controller touchpad.

FIG. 8C illustrates an example of the stand-alone controller ray casting method, in accordance with some embodiments. The controller ray casting system fails to resolve disambiguates in object selection in dense environments. For example, the controller ray casting system defaults to selecting a nearest object to the user that was intersected by the controller ray even if additional objects located further away are intersected by the controller ray.

FIG. 8D illustrates an example of the stand-alone controller ray casting method with a manual mode for object selection, in accordance with some embodiments. The manual mode is added to the controller ray casting system to enable users to manually adjust a depth for desired object selection. For example, the manual mode allows the user to increase the depth for object selection along the vector direction of the controller ray when the desired target object is located at a greater depth than a nearest object intersected by the controller ray.

The second study target environment consisted of four layers of uniformly distributed grids of spheres in the XR scene, each at different depths. One solid dark colored sphere served as the target, while the rest of the spheres were translucent white distractor objects. During each trial, a different sphere was assigned to be the target and the participant's task was to correctly select the target. When the current selection technique determined that a distractor was the candidate target, the distractor object changed color and/or shade to a lighter and/or highlighted translucent shade to indicate that the object was now selectable. When the target sphere was the candidate target, it was highlighted solid dark color, as illustrated in FIGS. 8A-8D. To select the highlighted target, the participant clicked the controller's trigger. If the participant had correctly selected the target sphere, the controller vibrated and the next trial started. If a distractor was selected, it would turn a translucent shade for 0.5 seconds before changing back to its default color, and the participant could try again. If the participant did not successfully select the target within 20 seconds, the controller emitted a long vibration and began the next trial.

Four layers of grids were rendered in the z-direction in uniform intervals. The depth of the first layer was 0.5 meters from the participant's position, and the depth of the last layer was 4 meters. For each grid of spheres in one layer, the grid's length and width were both 1.85 meters. The grid contained 100 uniformly distributed spheres, with 10 spheres in each row and each column of the grid. The diameter of each sphere was 20 centimeters. As all spheres had the same fixed diameter, the angular diameters of the spheres were different at each layer, with the numbers being 22.62 degrees, 6.87 degrees, 4.04 degrees, and 2.86 degrees respectively, from layers 1 to 4. Since the first layer was very close to the participant (i.e., 0.5 meters), the participant could not see all objects in the first grid at once in their FOV. The grids were set up such that all objects in the second layer were within the FOV. The size and density chosen for the spheres ensured that no spheres collided with each other, and that any target behind the first layer would be partially occluded.

For layers 2 to 4, every sphere appeared once as the target, for a total of 300 trials. For layer 1, only the 16 spheres (4×4) from the center-most positions of the grid were used once as the target, as these spheres were in the FOV when seen from the initial head position. Thus, 316 trials were used to evaluate each technique, resulting in 948 trials per participant. The target position during each trial was randomized. The order of the selection techniques was counterbalanced across participants.

For the second study, the stand-alone controller-ray casting method moved a cursor along the controller ray via thumb swipes on the controller's touchpad, highlighting the closest object to the cursor. To control the sensitivity of the swipes in manual mode, a transfer function was implemented, and the parameters of the transfer function were tweaked to suit the experimental extended-reality world's scale.

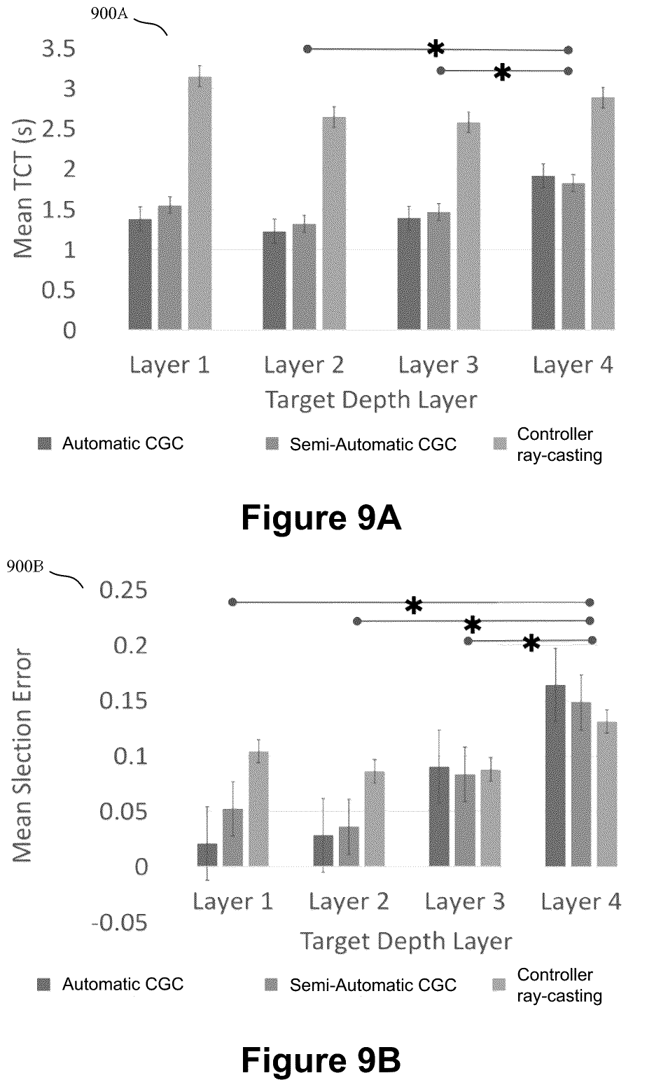

FIG. 9A shows an example chart for the variations in mean task completion time (TCT) versus target depth layer for each object selection system under evaluation in the second study, in accordance with embodiments. Both variations of the CGC systems outperformed the stand-alone controller-ray casting method, regardless of target object depth.

The TCT is the time taken for a user to select the target from when the target was first displayed. In some embodiments, the target depth is the layer that the target was positioned at within amongst the four layers of grids. In some embodiments, the TCT differed significantly based on target selection technique. For example, post-hoc tests revealed that the stand-alone controller-ray casting method (μ=2.73 seconds) was significantly slower than both variations of the CGC, the automatic CGC (μ=1.50 seconds) and the semi-automatic CGC (μ=1.53 seconds; FIG. 9). For example, the automatic CGC system resulted in faster TCT by 45.0% compared to the standalone controller ray-casting.

In some embodiments, TCT differed based on target depth. In some embodiments, post-hoc tests showed significant differences between layers 2 (1.73 seconds) and 4 (2.21 seconds), and layers 3 (1.81 seconds) and 4 (2.21 seconds). Targets located on layers 2, 3, and 4 were rendered behind distractor objects, and the post-hoc results showed that targets on these layers took more time to select. The interaction effect between selection technique and target depth was also found to be significant. The stand-alone controller-ray casting needed the highest TCT on depth layer 1 (3.15 seconds), and showed significant differences from layers 2 (2.64 seconds) and 3 (2.58 seconds). On the other hand, the two variations of the CGC system had no significant differences between layers 1, 2, and 3. The layer 4, the automatic CGC system had a higher TCT (1.91 seconds) as compared to layers 1, 2, and 3 (1.38, 1.22, 1.39 seconds, respectively).

In some embodiments, targets on layer 1, which were not occluded, had higher TCTs than targets positioned at farther depth layers. The increase in TCT for closer positioned objects could arise from users needing more time to make larger head movements to find and focus on targets located much closer in proximity.

In some embodiments, no significant difference in TCT was found between the automatic CGC and the semi-automatic CGC. The on-par performance of the two CGC systems is indicative that the blended gaze-ray and controller-ray target selection system performs accurately and fast and effectively eliminates the need for extra refinement steps via a manual mode of target selection and/or any other methods.

FIG. 9B shows an example chart for variations in the mean selection error versus target depth layer for each object selection system, in accordance with some embodiments. Asterisks indicate significantly different pairs of depth layers.

A selection error occurred whenever a participant selected an incorrect distractor object at least once before the target object was selected. No significant effect of technique on selection error rate (p=0.2), however target depth did have a significant main effect on selection error. Post-hoc analysis found that the mean selection error for depth layer 4 (μ=0.059) was significantly greater than layers 1, 2, and 3 (μ=0.050, 0.087, 0.148 respectively). No other significant differences were found between layers. The interaction effect between technique and target depth was found to be significant. FIG. 9B show the mean selection error for each technique at every target depth layer. At layers 1 and 2, automatic blended gaze and controller ray casting and semi-automatic blended gaze and controller ray casting had significantly lower selection errors than the controller raycasting method. The selection error for all 3 techniques were similar at layer 3.

In some embodiments, the manual mode was available with the controller raycasting method and the semi-CGC system to evaluate how often participants would use it to disambiguate between intersected objects. On average, participants used manual mode 96.4% of the time while using the controller raycasting method, and 9.4% of the time while using the semi-CGC system. All participants triggered manual mode using the controller raycasting method, while some participants did not trigger manual mode at all using the semi-CGC system. A high trigger rate was expected with the controller raycasting method, since the target was heavily obstructed by a dense number of distractor objects and the controller raycasting method's default raycasting highlighted the closest object to the participant, which was incorrect in most cases. In these cases, to select the target, the participant would need to manually adjust the cursor to move behind the distractors blocking the target. The manual mode trigger rate for the semi-CGC system was much lower, demonstrating that the CGC system by itself, without a manual mode or the semi-CGC system, was sufficient for selecting the desired target without manual intervention.

In some embodiments, a distance between the target object and the manual cursor displayed by the respective systems was computed when manual mode was first entered, as well as the time spent in manual mode, to gauge the effort needed to select a target using these techniques. The mean manual distance and time for participants who used manual mode at least once was 2.36 meters (SD=1.26) and 2.06 seconds (SD=0.56) for semi-CGC, while for the controller raycasting method it was 4.22 meters (SD=0.92) and 2.00 seconds (SD=0.40). Although the time spent in manual mode was similar for the two techniques, the semi-CGC system required a smaller distance for the manual cursor to reach the target sphere.

In some embodiments, the controller raycasting method required a longer time for the manual cursor to reach the target sphere, when manual mode was entered, because the starting position of the manual cursor would be near objects in layer 1. For the semi-CGC system, the initial manual cursor position was dependent on the last position of the projected intersection, which would be closer to the goal target since participants would try to focus their gaze near the target before entering manual mode. In some embodiments, the smaller manual adjustment distance traveled in the semi-CGC system leads to less user physical effort and fatigue.

In some embodiments, for the post-study questionnaire, participants' preferences were collected through several 5-point Likert scale questions and short answer comments. Participants rated each technique on how easy it was to select the goal target when it was directly in front of them, and when it was behind other distractor objects (1—hard, 5—easy). Friedman tests were conducted on the ratings with corrections for ties, and found a significant effect of technique on ease of selection when the target was at the front (χ2 (2)=15.077, p<0.001), and also when the target was behind other distractors (χ2 (2)=6.541, p<0.05). For example, post-hoc tests reported that when selecting targets in front, auto-CGC (median=5) and semi-CGC (median=5) showed significant differences compared to the controller raycasting method (median=4) with both variations of the CGC system offering improved target object selection. As another example, when selecting targets behind, the semi-CGC system (median=5) was found to be significantly easier to use compared to the controller raycasting method (median=3). In some embodiments, both variations of the CGC system provided similar performance for selecting targets located at a greater depth and behind other objects. In some embodiments, both variations of the CGC system provided fast and accurate target object selection without the need for a manual selection and/or additional disambiguation processes. By eliminating the manual disambiguation and/or extra refinement steps, the user experience was significantly elevated. For example, thumb and/or other hand injuries frequently experienced by prolonged use of controllers are avoided.

In some embodiments, the automatic CGC system enables fast and accurate selection of target objects located close to the user with no need for the semi-manual mode of operation of the CGC system. In some embodiments, for target objects located further away from the user, the semi-manual mode of operation of the CGC provides for increased accuracy in target object selection in crowded environments over the fully automated CCG system. In some embodiments, for users with gaze focus estimation issues, the semi-manual CGC system enables increased user control to compensate for the gaze focus estimation issues when target objects are located relatively further away from the user. For example, providing users with some manual control to offset user gaze focus issues helps with improved target object selection using the semi-manual CGC system and provides for an improvement in the overall user experience.

Additionally or alternatively, in some embodiments, the blended gaze and controller raycasting system additionally uses a shadow cone or cone selection technique for virtual object selection in XR environments based on a position of at least one handheld object selection controller device.

Additionally or alternatively, in some embodiments, the blended gaze and controller raycasting system uses alternative button locations on the controller for enabling more precise and subtle manipulation of the controller ray while minimizing selection errors that can arise from button press tremors (e.g., physical variations in the controller position from pressing the object selection button on the controller). The force needed to press the object selection button or trigger button can lead to shaking in the raycasting from the Heisenberg effect of spatial interaction. By combining the blended gaze and controller ray casting object selection and facilitation methods with uniquely designed controller buttons that minimize the controller raycasting tremors, the Blended gaze and controller raycasting system can further improve desired object selection accuracies.

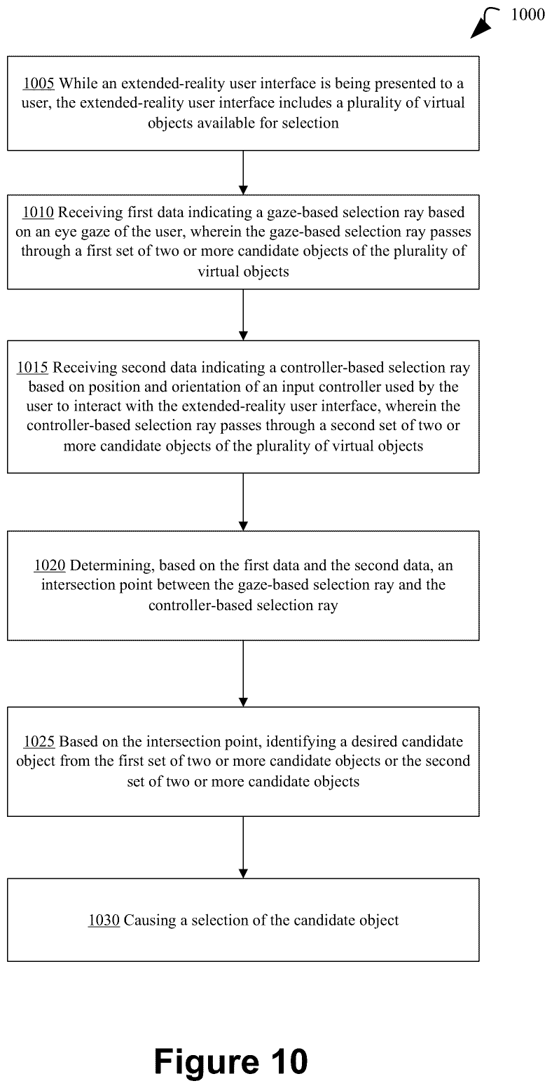

FIG. 10 shows a flowchart for a method 1000 for blended gaze and controller raycasting, in accordance with some embodiments. In some embodiments, while an extended-reality user interface is being presented to a user (1005), the extended-reality user interface includes a plurality of virtual objects available for selection. The system receives (1010) first data indicating a gaze-based selection ray based on an eye gaze of the user, wherein the gaze-based selection ray passes through a first set of two or more candidate objects of the plurality of virtual objects, and receives (1015) second data indicating a controller-based selection ray based on position and orientation of an input controller used by the user to interact with the extended-reality user interface, wherein the controller-based selection ray passes through a second set of two or more candidate objects of the plurality of virtual objects. The system determines (1020) based on the first data and the second data, an intersection point between the gaze-based selection ray and the controller-based selection ray and based on the intersection point (1025), identifies a desired candidate object from the first set of two or more candidate objects or the second set of two or more candidate objects. The system causes (1030) selection of the candidate object. In some embodiments, the system causes selection of the candidate object upon receiving a user input confirming that the object identified as the desired candidate is the object the user wants to select.

Examples of Input and Output Devices that can Benefit from Blended Gaze and Controller Ray Casting

The techniques (including blended gaze and controller ray casting) described above are further detailed below, including providing descriptions of example systems (including XR systems), wrist-wearable devices, headset devices, and smart textile-based garments that can take advantage of the blended gaze and controller ray casting target object selection for interfacing with users of XR environments. Specific operations described above may occur as a result of specific hardware, such hardware is described in further detail below. The devices described below are not necessarily limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 1100, a head-wearable device, an HIPD 1300, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) extended-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example Extended-Reality Systems 11A-11C-2

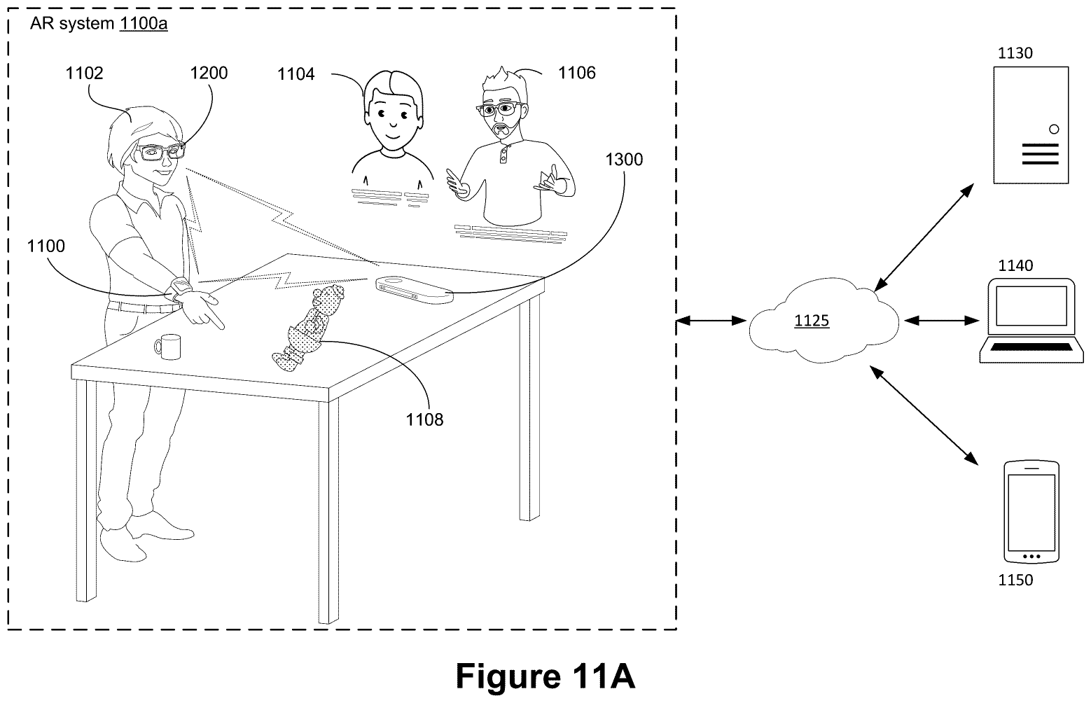

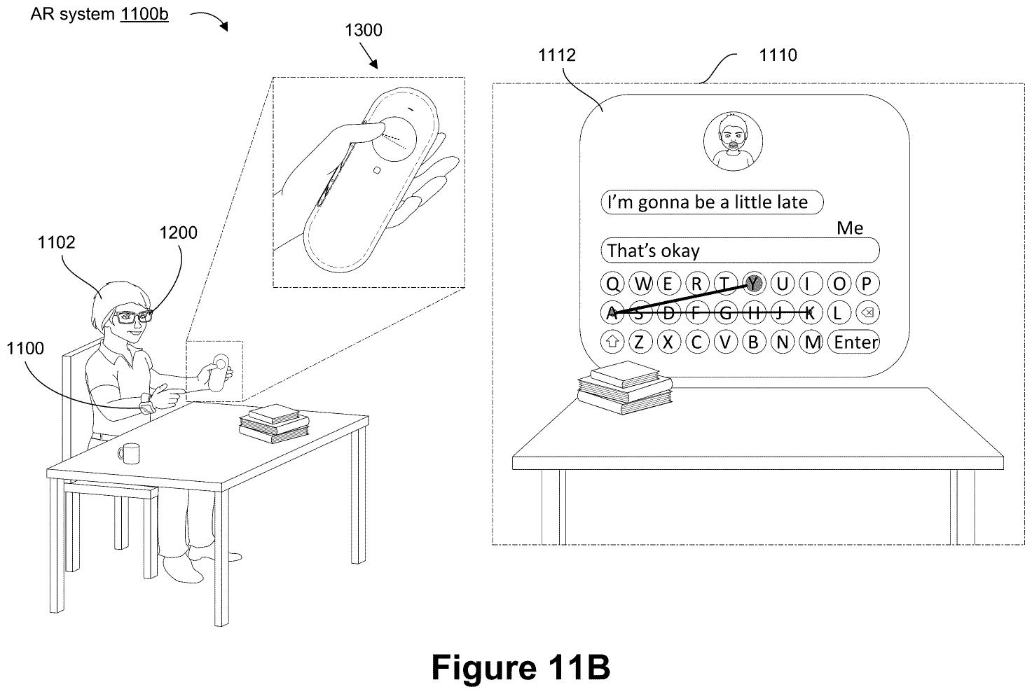

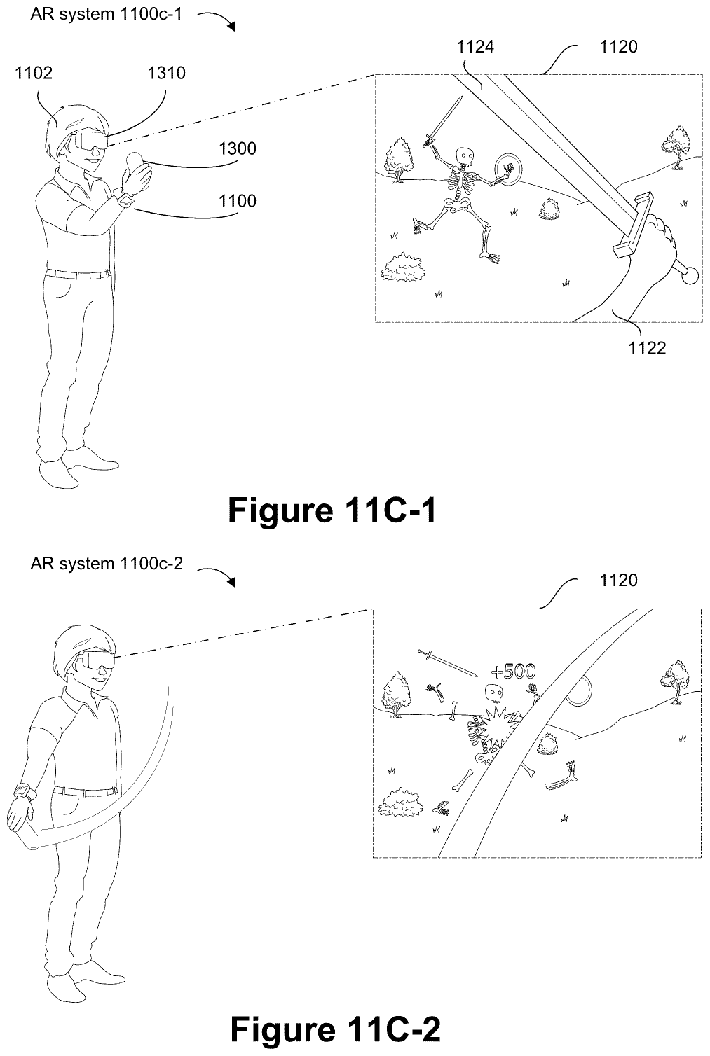

FIGS. 11A, 11B, 11C-1, and 11C-2 illustrate example XR systems, in accordance with some embodiments. FIG. 11A shows a first XR system 1100a and first example user interactions using a wrist-wearable device 1100, a head-wearable device (e.g., AR device 1200), and/or a handheld intermediary processing device (HIPD) 1300. FIG. 11B shows a second XR system 1100b and second example user interactions using a wrist-wearable device 1100, AR device 1200, and/or an HIPD 1300. FIGS. 11C-1 and 11C-2 show a third XR system 1100c and third example user interactions using a wrist-wearable device 1100, a head-wearable device (e.g., virtual-reality (VR) device 1310), and/or an HIPD 1300. As the skilled artisan will appreciate upon reading the descriptions provided herein, the above-example XR systems (described in detail below) can perform various functions and/or operations described above with reference to FIGS. 1A-9B.

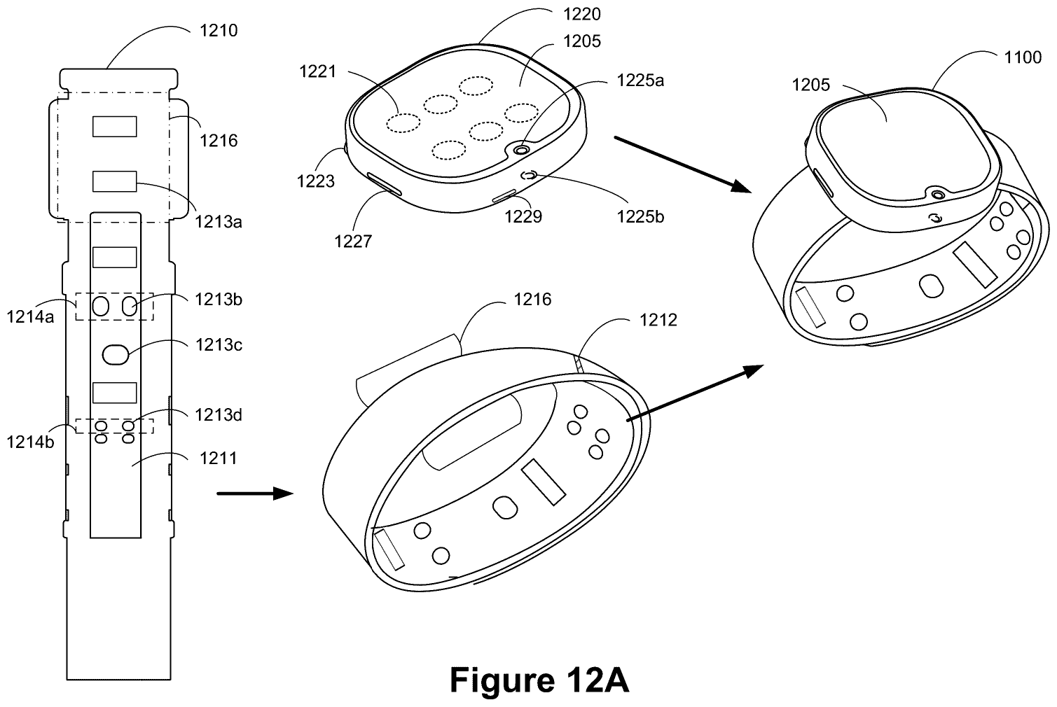

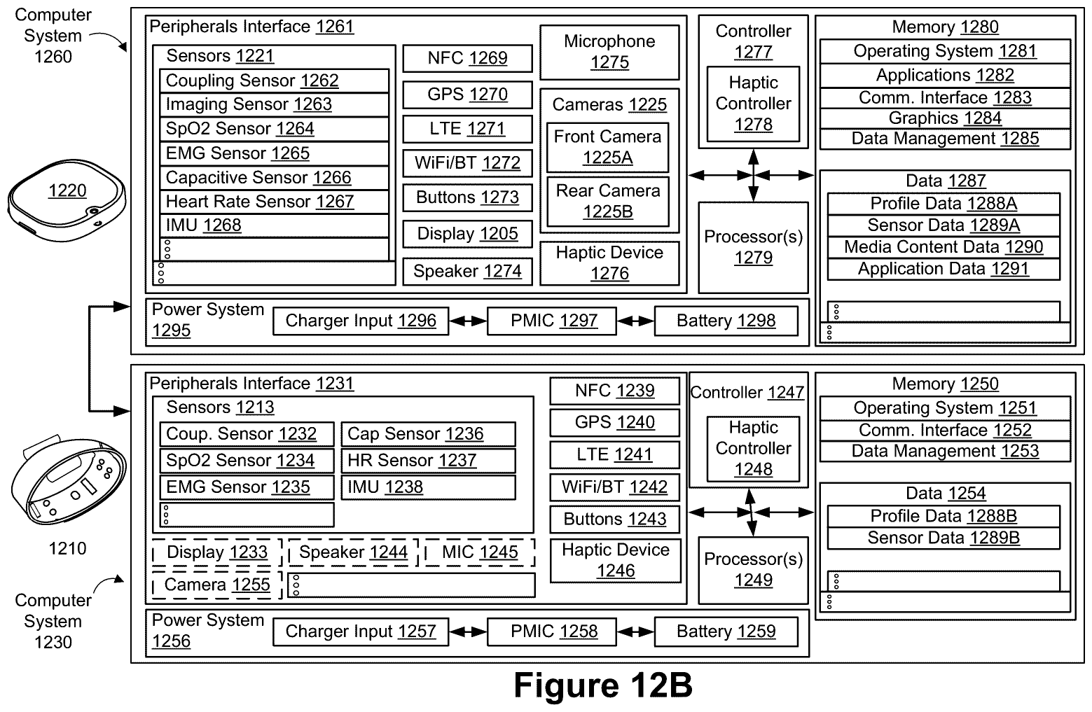

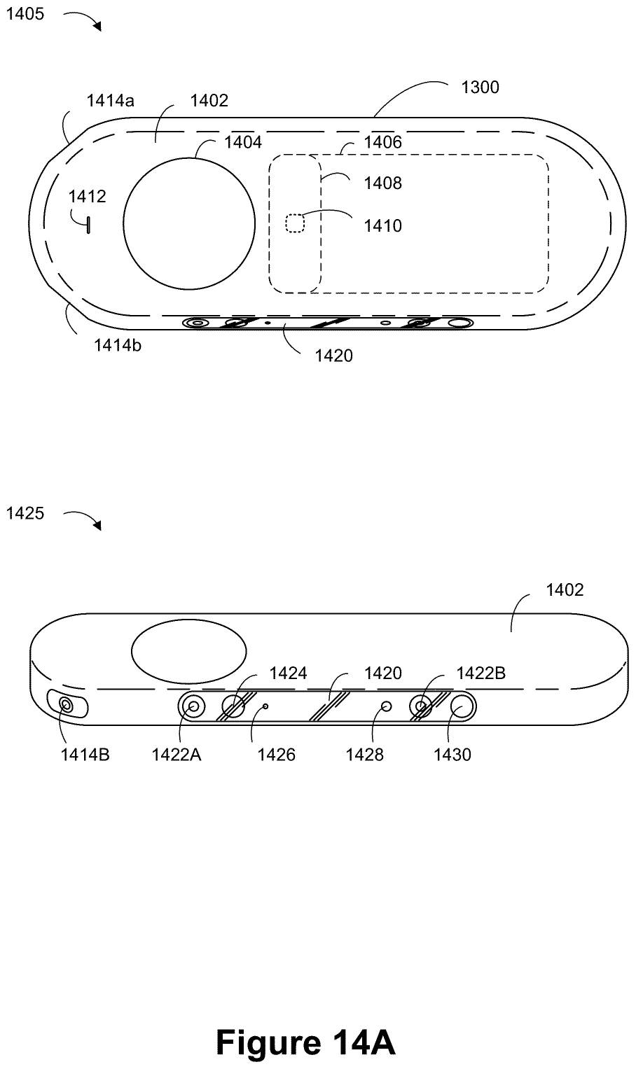

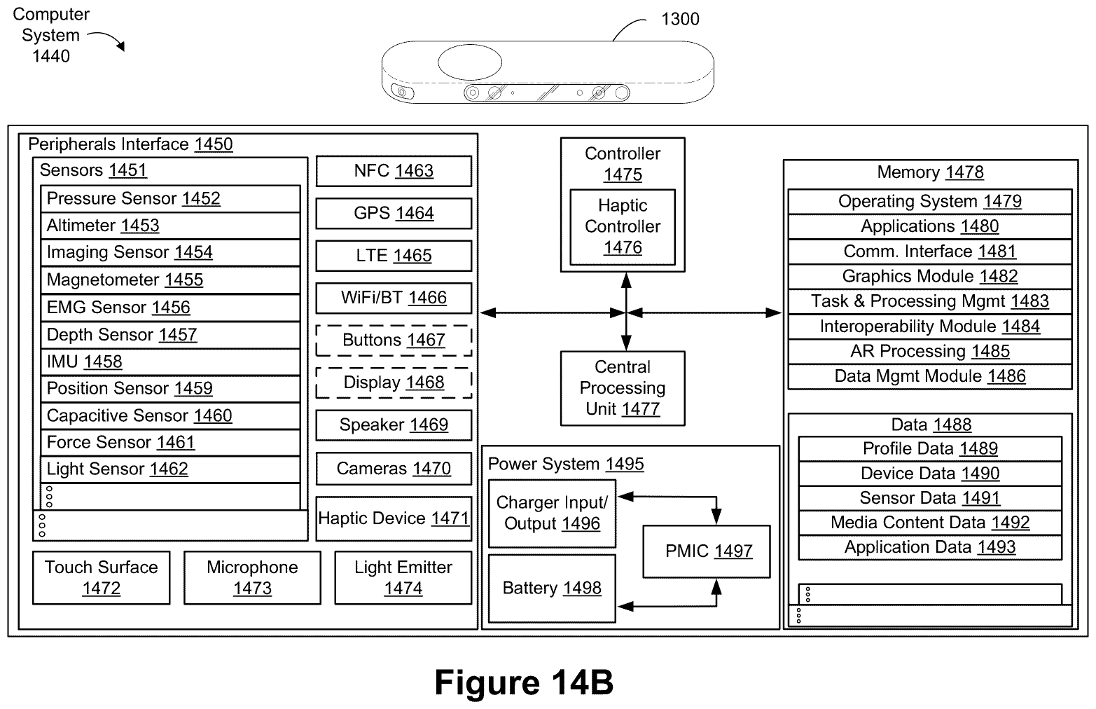

The wrist-wearable device 1100 and its constituent components are described below in reference to FIGS. 11A-11B, the head-wearable devices and their constituent components are described below in reference to FIGS. 12A-12D, and the HIPD 1300 and its constituent components are described below in reference to FIGS. 14A-14B. The wrist-wearable device 1100, the head-wearable devices, and/or the HIPD 1300 can communicatively couple via a network 1125 (e.g., cellular, near field, Wi-Fi, personal area network, or wireless LAN). Additionally, the wrist-wearable device 1100, the head-wearable devices, and/or the HIPD 1300 can also communicatively couple with one or more servers 1130, computers 1140 (e.g., laptops or computers), mobile devices 1150 (e.g., smartphones or tablets), and/or other electronic devices via the network 1125 (e.g., cellular, near field, Wi-Fi, personal area network, or wireless LAN).

Turning to FIG. 11A, a user 1102 is shown wearing the wrist-wearable device 1100 and the AR device 1200, and having the HIPD 1300 on their desk. The wrist-wearable device 1100, the AR device 1200, and the HIPD 1300 facilitate user interaction with an AR environment. In particular, as shown by the first XR system 1100a, the wrist-wearable device 1100, the AR device 1200, and/or the HIPD 1300 cause presentation of one or more avatars 1104, digital representations of contacts 1106, and virtual objects 1108. As discussed below, the user 1102 can interact with the one or more avatars 1104, digital representations of the contacts 1106, and virtual objects 1108 via the wrist-wearable device 1100, the AR device 1200, and/or the HIPD 1300.

The user 1102 can use any of the wrist-wearable device 1100, the AR device 1200, and/or the HIPD 1300 to provide user inputs. For example, the user 1102 can perform one or more hand gestures that are detected by the wrist-wearable device 1100 (e.g., using one or more EMG sensors and/or IMUs, described below in reference to FIGS. 11A-11B) and/or AR device 1200 (e.g., using one or more image sensors or cameras, described below in reference to FIGS. 12A-12B) to provide a user input. Alternatively, or additionally, the user 1102 can provide a user input via one or more touch surfaces of the wrist-wearable device 1100, the AR device 1200, and/or the HIPD 1300, and/or voice commands captured by a microphone of the wrist-wearable device 1100, the AR device 1200, and/or the HIPD 1300. In some embodiments, the wrist-wearable device 1100, the AR device 1200, and/or the HIPD 1300 include a digital assistant to help the user in providing a user input (e.g., completing a sequence of operations, suggesting different operations or commands, providing reminders, or confirming a command). In some embodiments, the user 1102 can provide a user input via one or more facial gestures and/or facial expressions. For example, cameras of the wrist-wearable device 1100, the AR device 1200, and/or the HIPD 1300 can track the user 1102's eyes for navigating a user interface.

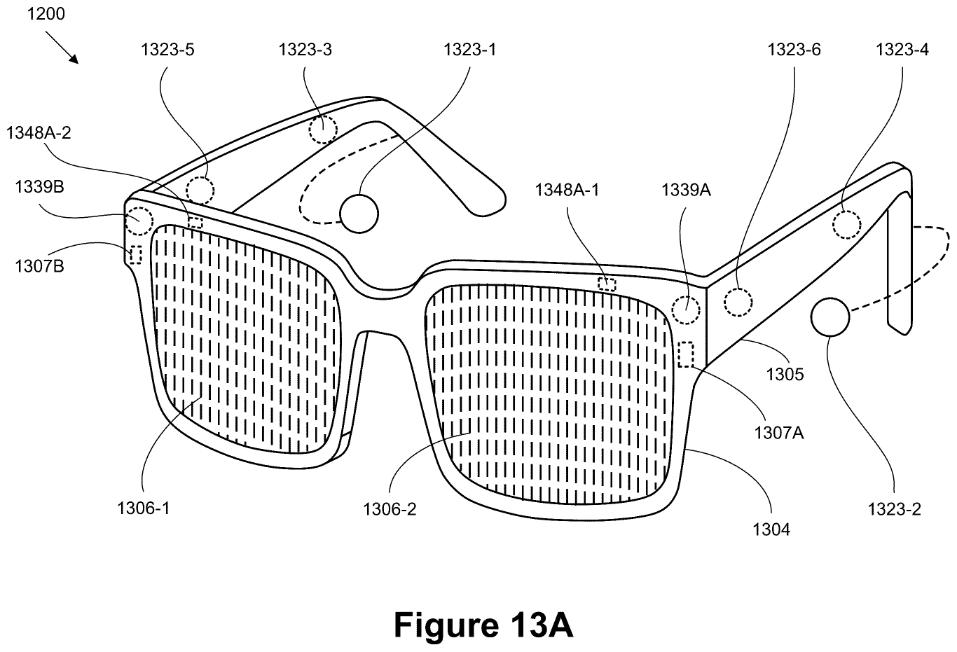

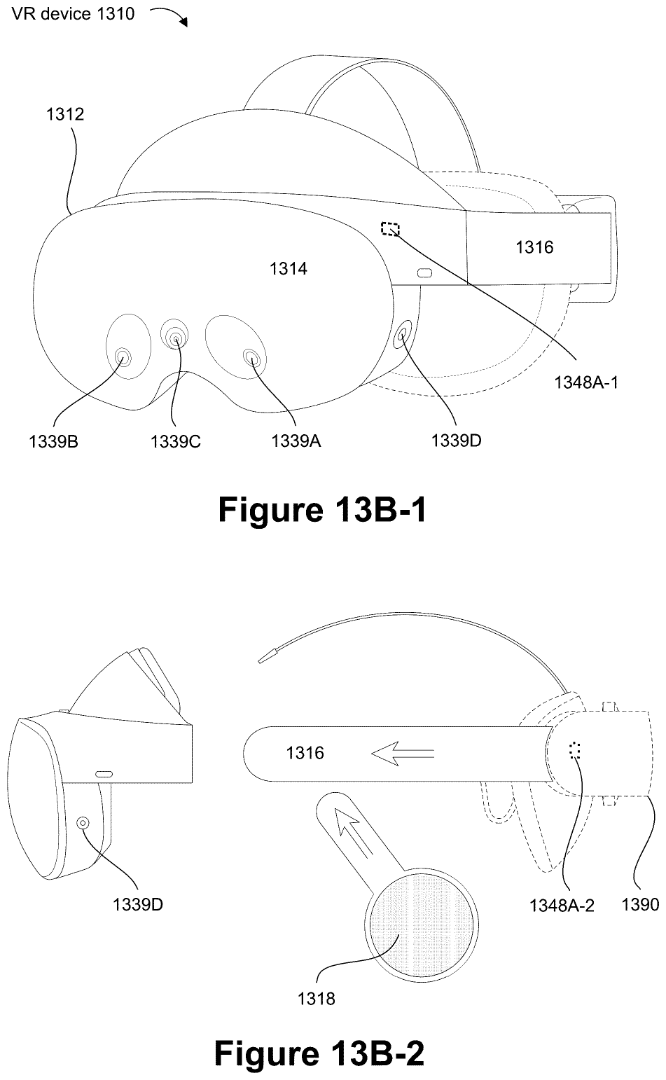

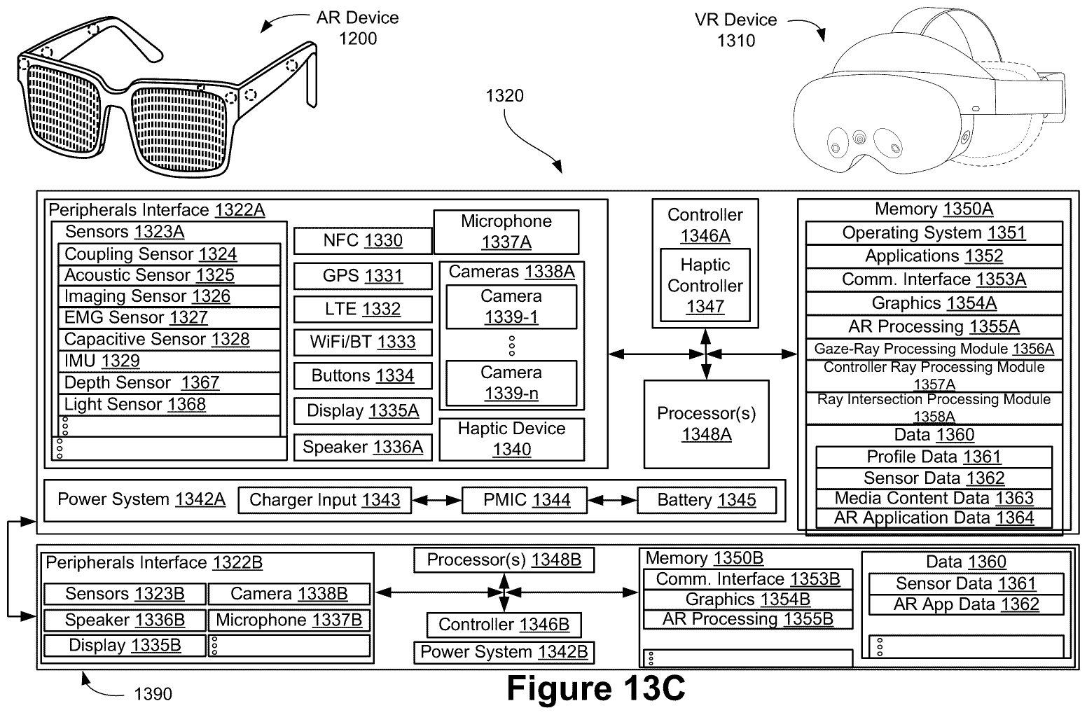

The wrist-wearable device 1100, the AR device 1200, and/or the HIPD 1300 can operate alone or in conjunction to allow the user 1102 to interact with the AR environment. In some embodiments, the HIPD 1300 is configured to operate as a central hub or control center for the wrist-wearable device 1100, the AR device 1200, and/or another communicatively coupled device. For example, the user 1102 can provide an input to interact with the AR environment at any of the wrist-wearable device 1100, the AR device 1200, and/or the HIPD 1300, and the HIPD 1300 can identify one or more back-end and front-end tasks to cause the performance of the requested interaction and distribute instructions to cause the performance of the one or more back-end and front-end tasks at the wrist-wearable device 1100, the AR device 1200, and/or the HIPD 1300. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 13A-13B, the HIPD 1300 can perform the back-end tasks and provide the wrist-wearable device 1100 and/or the AR device 1200 operational data corresponding to the performed back-end tasks such that the wrist-wearable device 1100 and/or the AR device 1200 can perform the front-end tasks. In this way, the HIPD 1300, which has more computational resources and greater thermal headroom than the wrist-wearable device 1100 and/or the AR device 1200, performs computationally intensive tasks and reduces the computer resource utilization and/or power usage of the wrist-wearable device 1100 and/or the AR device 1200.

In the example shown by the first XR system 1100a, the HIPD 1300 identifies one or more back-end tasks and front-end tasks associated with a user request to initiate an AR video call with one or more other users (represented by the avatar 1104 and the digital representation of the contact 1106) and distributes instructions to cause the performance of the one or more back-end tasks and front-end tasks. In particular, the HIPD 1300 performs back-end tasks for processing and/or rendering image data (and other data) associated with the AR video call and provides operational data associated with the performed back-end tasks to the AR device 1200 such that the AR device 1200 performs front-end tasks for presenting the AR video call (e.g., presenting the avatar 1104 and the digital representation of the contact 1106).

In some embodiments, the HIPD 1300 can operate as a focal or anchor point for causing the presentation of information. This allows the user 1102 to be generally aware of where information is presented. For example, as shown in the first XR system 1100a, the avatar 1104 and the digital representation of the contact 1106 are presented above the HIPD 1300. In particular, the HIPD 1300 and the AR device 1200 operate in conjunction to determine a location for presenting the avatar 1104 and the digital representation of the contact 1106. In some embodiments, information can be presented within a predetermined distance from the HIPD 1300 (e.g., within five meters). For example, as shown in the first XR system 1100a, virtual object 1108 is presented on the desk some distance from the HIPD 1300. Similar to the above example, the HIPD 1300 and the AR device 1200 can operate in conjunction to determine a location for presenting the virtual object 1108. Alternatively, in some embodiments, presentation of information is not bound by the HIPD 1300. More specifically, the avatar 1104, the digital representation of the contact 1106, and the virtual object 1108 do not have to be presented within a predetermined distance of the HIPD 1300.

User inputs provided at the wrist-wearable device 1100, the AR device 1200, and/or the HIPD 1300 are coordinated such that the user can use any device to initiate, continue, and/or complete an operation. For example, the user 1102 can provide a user input to the AR device 1200 to cause the AR device 1200 to present the virtual object 1108 and, while the virtual object 1108 is presented by the AR device 1200, the user 1102 can provide one or more hand gestures via the wrist-wearable device 1100 to interact and/or manipulate the virtual object 1108.

FIG. 11B shows the user 1102 wearing the wrist-wearable device 1100 and the AR device 1200, and holding the HIPD 1300. In the second XR system 1100b, the wrist-wearable device 1100, the AR device 1200, and/or the HIPD 1300 are used to receive and/or provide one or more messages to a contact of the user 1102. In particular, the wrist-wearable device 1100, the AR device 1200, and/or the HIPD 1300 detect and coordinate one or more user inputs to initiate a messaging application and prepare a response to a received message via the messaging application.

In some embodiments, the user 1102 initiates, via a user input, an application on the wrist-wearable device 1100, the AR device 1200, and/or the HIPD 1300 that causes the application to initiate on at least one device. For example, in the second XR system 1100b, the user 1102 performs a hand gesture associated with a command for initiating a messaging application (represented by messaging user interface 1112), the wrist-wearable device 1100 detects the hand gesture, and, based on a determination that the user 1102 is wearing AR device 1200, causes the AR device 1200 to present a messaging user interface 1112 of the messaging application. The AR device 1200 can present the messaging user interface 1112 to the user 1102 via its display (e.g., as shown by user 1102's field of view 1110). In some embodiments, the application is initiated and can be run on the device (e.g., the wrist-wearable device 1100, the AR device 1200, and/or the HIPD 1300) that detects the user input to initiate the application, and the device provides another device operational data to cause the presentation of the messaging application. For example, the wrist-wearable device 1100 can detect the user input to initiate a messaging application, initiate and run the messaging application, and provide operational data to the AR device 1200 and/or the HIPD 1300 to cause presentation of the messaging application. Alternatively, the application can be initiated and run at a device other than the device that detected the user input. For example, the wrist-wearable device 1100 can detect the hand gesture associated with initiating the messaging application and cause the HIPD 1300 to run the messaging application and coordinate the presentation of the messaging application.

Further, the user 1102 can provide a user input provided at the wrist-wearable device 1100, the AR device 1200, and/or the HIPD 1300 to continue and/or complete an operation initiated at another device. For example, after initiating the messaging application via the wrist-wearable device 1100 and while the AR device 1200 presents the messaging user interface 1112, the user 1102 can provide an input at the HIPD 1300 to prepare a response (e.g., shown by the swipe gesture performed on the HIPD 1300). The user 1102's gestures performed on the HIPD 1300 can be provided and/or displayed on another device. For example, the user 1102's swipe gestures performed on the HIPD 1300 are displayed on a virtual keyboard of the messaging user interface 1112 displayed by the AR device 1200.

In some embodiments, the wrist-wearable device 1100, the AR device 1200, the HIPD 1300, and/or other communicatively coupled devices can present one or more notifications to the user 1102. The notification can be an indication of a new message, an incoming call, an application update, a status update, etc. The user 1102 can select the notification via the wrist-wearable device 1100, the AR device 1200, or the HIPD 1300 and cause presentation of an application or operation associated with the notification on at least one device. For example, the user 1102 can receive a notification that a message was received at the wrist-wearable device 1100, the AR device 1200, the HIPD 1300, and/or other communicatively coupled device and provide a user input at the wrist-wearable device 1100, the AR device 1200, and/or the HIPD 1300 to review the notification, and the device detecting the user input can cause an application associated with the notification to be initiated and/or presented at the wrist-wearable device 1100, the AR device 1200, and/or the HIPD 1300.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1200 can present to the user 1102 game application data and the HIPD 1300 can use a controller to provide inputs to the game. Similarly, the user 1102 can use the wrist-wearable device 1100 to initiate a camera of the AR device 1200, and the user can use the wrist-wearable device 1100, the AR device 1200, and/or the HIPD 1300 to manipulate the image capture (e.g., zoom in or out or apply filters) and capture image data.

Turning to FIGS. 11C-1 and 11C-2, the user 1102 is shown wearing the wrist-wearable device 1100 and a VR device 1310, and holding the HIPD 1300. In the third XR system 1100c, the wrist-wearable device 1100, the VR device 1310, and/or the HIPD 1300 are used to interact within an AR environment, such as a VR game or other AR application. While the VR device 1310 presents a representation of a VR game (e.g., first AR game environment 1120) to the user 1102, the wrist-wearable device 1100, the VR device 1310, and/or the HIPD 1300 detect and coordinate one or more user inputs to allow the user 1102 to interact with the VR game.

In some embodiments, the user 1102 can provide a user input via the wrist-wearable device 1100, the VR device 1310, and/or the HIPD 1300 that causes an action in a corresponding AR environment. For example, the user 1102 in the third XR system 1100c (shown in FIG. 11C-1) raises the HIPD 1300 to prepare for a swing in the first AR game environment 1120. The VR device 1310, responsive to the user 1102 raising the HIPD 1300, causes the AR representation of the user 1122 to perform a similar action (e.g., raise a virtual object, such as a virtual sword 1124). In some embodiments, each device uses respective sensor data and/or image data to detect the user input and provide an accurate representation of the user 1102's motion. For example, image sensors 1358 (e.g., SLAM cameras or other cameras discussed below in FIGS. 13A and 13B) of the HIPD 1300 can be used to detect a position of the 1300 relative to the user 1102's body such that the virtual object can be positioned appropriately within the first AR game environment 1120; sensor data from the wrist-wearable device 1100 can be used to detect a velocity at which the user 1102 raises the HIPD 1300 such that the AR representation of the user 1122 and the virtual sword 1124 are synchronized with the user 1102's movements; and image sensors 1226 (FIGS. 12A-12C) of the VR device 1310 can be used to represent the user 1102's body, boundary conditions, or real-world objects within the first AR game environment 1120.

In FIG. 11C-2, the user 1102 performs a downward swing while holding the HIPD 1300. The user 1102's downward swing is detected by the wrist-wearable device 1100, the VR device 1310, and/or the HIPD 1300 and a corresponding action is performed in the first AR game environment 1120. In some embodiments, the data captured by each device is used to improve the user's experience within the AR environment. For example, sensor data of the wrist-wearable device 1100 can be used to determine a speed and/or force at which the downward swing is performed and image sensors of the HIPD 1300 and/or the VR device 1310 can be used to determine a location of the swing and how it should be represented in the first AR game environment 1120, which, in turn, can be used as inputs for the AR environment (e.g., game mechanics, which can use detected speed, force, locations, and/or aspects of the user 1102's actions to classify a user's inputs (e.g., user performs a light strike, hard strike, critical strike, glancing strike, miss) or calculate an output (e.g., amount of damage)).

While the wrist-wearable device 1100, the VR device 1310, and/or the HIPD 1300 are described as detecting user inputs, in some embodiments, user inputs are detected at a single device (with the single device being responsible for distributing signals to the other devices for performing the user input). For example, the HIPD 1300 can operate an application for generating the first AR game environment 1120 and provide the VR device 1310 with corresponding data for causing the presentation of the first AR game environment 1120, as well as detect the 1102's movements (while holding the HIPD 1300) to cause the performance of corresponding actions within the first AR game environment 1120. Additionally or alternatively, in some embodiments, operational data (e.g., sensor data, image data, application data, device data, and/or other data) of one or more devices is provide to a single device (e.g., the HIPD 1300) to process the operational data and cause respective devices to perform an action associated with processed operational data.

Having discussed example XR systems, devices for interacting with such XR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 12A and 12B illustrate an example wrist-wearable device 1100, in accordance with some embodiments. The wrist-wearable device 1100 is an instance of the wearable device that can be used in conjunction with the hand controller or AR/VR headsets described in reference to FIGS. 1A-9B herein, such that the wrist-wearable device should be understood to have the features of the wrist-wearable device 1100 and vice versa. FIG. 12A illustrates components of the wrist-wearable device 1100, which can be used individually or in combination, including combinations that include other electronic devices and/or electronic components.

FIG. 12A shows a wearable band 1210 and a watch body 1220 (or capsule) being coupled, as discussed below, to form the wrist-wearable device 1100. The wrist-wearable device 1100 can perform various functions and/or operations associated with navigating through user interfaces and selectively opening applications, as well as the functions and/or operations described above with reference to FIGS. 1A-9B.

As will be described in more detail below, operations executed by the wrist-wearable device 1100 can include (i) presenting content to a user (e.g., displaying visual content via a display 1205); (ii) detecting (e.g., sensing) user input (e.g., sensing a touch on peripheral button 1223 and/or at a touch screen of the display 1205, a hand gesture detected by sensors (e.g., biopotential sensors)); (iii) sensing biometric data via one or more sensors 1213 (e.g., neuromuscular signals, heart rate, temperature, or sleep); messaging (e.g., text, speech, or video); image capture via one or more imaging devices or cameras 1225; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 1220, independently in the wearable band 1210, and/or via an electronic communication between the watch body 1220 and the wearable band 1210. In some embodiments, functions can be executed on the wrist-wearable device 1100 while an AR environment is being presented (e.g., via one of the XR systems 1000a to 1000d). As the skilled artisan will appreciate upon reading the descriptions provided herein, the novel wearable devices described herein can be used with other types of AR environments.

The wearable band 1210 can be configured to be worn by a user such that an inner (or inside) surface of the wearable structure 1211 of the wearable band 1210 is in contact with the user's skin. When worn by a user, sensors 1213 contact the user's skin. The sensors 1213 can sense biometric data such as a user's heart rate, saturated oxygen level, temperature, sweat level, neuromuscular-signal sensors, or a combination thereof. The sensors 1213 can also sense data about a user's environment, including a user's motion, altitude, location, orientation, gait, acceleration, position, or a combination thereof. In some embodiments, the sensors 1213 are configured to track a position and/or motion of the wearable band 1210. The one or more sensors 1213 can include any of the sensors defined above and/or discussed below with respect to FIG. 12B.

The one or more sensors 1213 can be distributed on an inside and/or an outside surface of the wearable band 1210. In some embodiments, the one or more sensors 1213 are uniformly spaced along the wearable band 1210. Alternatively, in some embodiments, the one or more sensors 1213 are positioned at distinct points along the wearable band 1210. As shown in FIG. 12A, the one or more sensors 1213 can be the same or distinct. For example, in some embodiments, the one or more sensors 1213 can be shaped as a pill (e.g., sensor 1213a), an oval, a circle a square, an oblong (e.g., sensor 1213c), and/or any other shape that maintains contact with the user's skin (e.g., such that neuromuscular signal and/or other biometric data can be accurately measured at the user's skin). In some embodiments, the one or more sensors 1213 are aligned to form pairs of sensors (e.g., for sensing neuromuscular signals based on differential sensing within each respective sensor). For example, sensor 1213b is aligned with an adjacent sensor to form sensor pair 1214a, and sensor 1213d is aligned with an adjacent sensor to form sensor pair 1214b. In some embodiments, the wearable band 1210 does not have a sensor pair. Alternatively, in some embodiments, the wearable band 1210 has a predetermined number of sensor pairs (one pair of sensors, three pairs of sensors, four pairs of sensors, six pairs of sensors, or sixteen pairs of sensors).

The wearable band 1210 can include any suitable number of sensors 1213. In some embodiments, the amount and arrangements of sensors 1213 depend on the particular application for which the wearable band 1210 is used. For instance, a wearable band 1210 configured as an armband, wristband, or chest-band may includes a plurality of sensors 1213 with a different number of sensors 1213 and different arrangement for each use case, such as medical use cases, compared to gaming or general day-to-day use cases.

In accordance with some embodiments, the wearable band 1210 further includes an electrical ground electrode and a shielding electrode. The electrical ground and shielding electrodes, like the sensors 1213, can be distributed on the inside surface of the wearable band 1210 such that they contact a portion of the user's skin. For example, the electrical ground and shielding electrodes can be at an inside surface of coupling mechanism 1216 or an inside surface of a wearable structure 1211. The electrical ground and shielding electrodes can be formed and/or use the same components as the sensors 1213. In some embodiments, the wearable band 1210 includes more than one electrical ground electrode and more than one shielding electrode.

The sensors 1213 can be formed as part of the wearable structure 1211 of the wearable band 1210. In some embodiments, the sensors 1213 are flush or substantially flush with the wearable structure 1211 such that they do not extend beyond the surface of the wearable structure 1211. While flush with the wearable structure 1211, the sensors 1213 are still configured to contact the user's skin (e.g., via a skin-contacting surface). Alternatively, in some embodiments, the sensors 1213 extend beyond the wearable structure 1211 a predetermined distance (e.g., 0.1 mm to 2 mm) to make contact and depress into the user's skin. In some embodiments, the sensors 1213 are coupled to an actuator (not shown) configured to adjust an extension height (e.g., a distance from the surface of the wearable structure 1211) of the sensors 1213 such that the sensors 1213 make contact and depress into the user's skin. In some embodiments, the actuators adjust the extension height between 0.01 mm to 1.2 mm. This allows the user to customize the positioning of the sensors 1213 to improve the overall comfort of the wearable band 1210 when worn while still allowing the sensors 1213 to contact the user's skin. In some embodiments, the sensors 1213 are indistinguishable from the wearable structure 1211 when worn by the user.

The wearable structure 1211 can be formed of an elastic material, elastomers, etc., configured to be stretched and fitted to be worn by the user. In some embodiments, the wearable structure 1211 is a textile or woven fabric. As described above, the sensors 1213 can be formed as part of a wearable structure 1211. For example, the sensors 1213 can be molded into the wearable structure 1211 or be integrated into a woven fabric (e.g., the sensors 1213 can be sewn into the fabric and mimic the pliability of fabric (e.g., the sensors 1213 can be constructed from a series of woven strands of fabric)).

The wearable structure 1211 can include flexible electronic connectors that interconnect the sensors 1213, the electronic circuitry, and/or other electronic components (described below in reference to FIG. 12B) that are enclosed in the wearable band 1210. In some embodiments, the flexible electronic connectors are configured to interconnect the sensors 1213, the electronic circuitry, and/or other electronic components of the wearable band 1210 with respective sensors and/or other electronic components of another electronic device (e.g., watch body 1220). The flexible electronic connectors are configured to move with the wearable structure 1211 such that the user adjustment to the wearable structure 1211 (e.g., resizing, pulling, or folding) does not stress or strain the electrical coupling of components of the wearable band 1210.

As described above, the wearable band 1210 is configured to be worn by a user. In particular, the wearable band 1210 can be shaped or otherwise manipulated to be worn by a user. For example, the wearable band 1210 can be shaped to have a substantially circular shape such that it can be configured to be worn on the user's lower arm or wrist. Alternatively, the wearable band 1210 can be shaped to be worn on another body part of the user, such as the user's upper arm (e.g., around a bicep), forearm, chest, legs, etc. The wearable band 1210 can include a retaining mechanism 1212 (e.g., a buckle or a hook and loop fastener) for securing the wearable band 1210 to the user's wrist or other body part. While the wearable band 1210 is worn by the user, the sensors 1213 sense data (referred to as sensor data) from the user's skin. In particular, the sensors 1213 of the wearable band 1210 obtain (e.g., sense and record) neuromuscular signals.

The sensed data (e.g., sensed neuromuscular signals) can be used to detect and/or determine the user's intention to perform certain motor actions. In particular, the sensors 1213 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1205 of the wrist-wearable device 1100 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1213 can be used to provide a user with an enhanced interaction with a physical object (e.g., devices communicatively coupled with the wearable band 1210) and/or a virtual object in an AR application generated by an XR system (e.g., user interface objects presented on the display 1205 or another computing device (e.g., a smartphone)).

In some embodiments, the wearable band 1210 includes one or more haptic devices 1246 (FIG. 12B; e.g., a vibratory haptic actuator) that are configured to provide haptic feedback (e.g., a cutaneous and/or kinesthetic sensation) to the user's skin. The sensors 1213 and/or the haptic devices 1246 can be configured to operate in conjunction with multiple applications including, without limitation, health monitoring, social media, games, and AR (e.g., the applications associated with AR).

The wearable band 1210 can also include a coupling mechanism 1216 (e.g., a cradle or a shape of the coupling mechanism can correspond to the shape of the watch body 1220 of the wrist-wearable device 1100) for detachably coupling a capsule (e.g., a computing unit) or watch body 1220 (via a coupling surface of the watch body 1220) to the wearable band 1210. In particular, the coupling mechanism 1216 can be configured to receive a coupling surface proximate to the bottom side of the watch body 1220 (e.g., a side opposite to a front side of the watch body 1220 where the display 1205 is located), such that a user can push the watch body 1220 downward into the coupling mechanism 1216 to attach the watch body 1220 to the coupling mechanism 1216. In some embodiments, the coupling mechanism 1216 can be configured to receive a top side of the watch body 1220 (e.g., a side proximate to the front side of the watch body 1220 where the display 1205 is located) that is pushed upward into the cradle, as opposed to being pushed downward into the coupling mechanism 1216. In some embodiments, the coupling mechanism 1216 is an integrated component of the wearable band 1210 such that the wearable band 1210 and the coupling mechanism 1216 are a single unitary structure. In some embodiments, the coupling mechanism 1216 is a type of frame or shell that allows the watch body 1220 coupling surface to be retained within or on the wearable band 1210 coupling mechanism 1216 (e.g., a cradle, a tracker band, a support base, or a clasp).

The coupling mechanism 1216 can allow for the watch body 1220 to be detachably coupled to the wearable band 1210 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 1220 to the wearable band 1210 and to decouple the watch body 1220 from the wearable band 1210. For example, a user can twist, slide, turn, push, pull, or rotate the watch body 1220 relative to the wearable band 1210, or a combination thereof, to attach the watch body 1220 to the wearable band 1210 and to detach the watch body 1220 from the wearable band 1210. Alternatively, as discussed below, in some embodiments, the watch body 1220 can be decoupled from the wearable band 1210 by actuation of the release mechanism 1229.

The wearable band 1210 can be coupled with a watch body 1220 to increase the functionality of the wearable band 1210 (e.g., converting the wearable band 1210 into a wrist-wearable device 1100, adding an additional computing unit and/or battery to increase computational resources and/or a battery life of the wearable band 1210, or adding additional sensors to improve sensed data). As described above, the wearable band 1210 (and the coupling mechanism 1216) is configured to operate independently (e.g., execute functions independently) from watch body 1220. For example, the coupling mechanism 1216 can include one or more sensors 1213 that contact a user's skin when the wearable band 1210 is worn by the user and provide sensor data for determining control commands.

A user can detach the watch body 1220 (or capsule) from the wearable band 1210 in order to reduce the encumbrance of the wrist-wearable device 1100 to the user. For embodiments in which the watch body 1220 is removable, the watch body 1220 can be referred to as a removable structure, such that in these embodiments the wrist-wearable device 1100 includes a wearable portion (e.g., the wearable band 1210) and a removable structure (the watch body 1220).

Turning to the watch body 1220, the watch body 1220 can have a substantially rectangular or circular shape. The watch body 1220 is configured to be worn by the user on their wrist or on another body part. More specifically, the watch body 1220 is sized to be easily carried by the user, attached on a portion of the user's clothing, and/or coupled to the wearable band 1210 (forming the wrist-wearable device 1100). As described above, the watch body 1220 can have a shape corresponding to the coupling mechanism 1216 of the wearable band 1210. In some embodiments, the watch body 1220 includes a single release mechanism 1229 or multiple release mechanisms (e.g., two release mechanisms 1229 positioned on opposing sides of the watch body 1220, such as spring-loaded buttons) for decoupling the watch body 1220 and the wearable band 1210. The release mechanism 1229 can include, without limitation, a button, a knob, a plunger, a handle, a lever, a fastener, a clasp, a dial, a latch, or a combination thereof.

A user can actuate the release mechanism 1229 by pushing, turning, lifting, depressing, shifting, or performing other actions on the release mechanism 1229. Actuation of the release mechanism 1229 can release (e.g., decouple) the watch body 1220 from the coupling mechanism 1216 of the wearable band 1210, allowing the user to use the watch body 1220 independently from wearable band 1210 and vice versa. For example, decoupling the watch body 1220 from the wearable band 1210 can allow the user to capture images using rear-facing camera 1225b. Although the coupling mechanism 1216 is shown positioned at a corner of watch body 1220, the release mechanism 1229 can be positioned anywhere on watch body 1220 that is convenient for the user to actuate. In addition, in some embodiments, the wearable band 1210 can also include a respective release mechanism for decoupling the watch body 1220 from the coupling mechanism 1216. In some embodiments, the release mechanism 1229 is optional and the watch body 1220 can be decoupled from the coupling mechanism 1216, as described above (e.g., via twisting or rotating).

The watch body 1220 can include one or more peripheral buttons 1223 and 1227 for performing various operations at the watch body 1220. For example, the peripheral buttons 1223 and 1227 can be used to turn on or wake (e.g., transition from a sleep state to an active state) the display 1205, unlock the watch body 1220, increase or decrease volume, increase or decrease brightness, interact with one or more applications, interact with one or more user interfaces. Additionally, or alternatively, in some embodiments, the display 1205 operates as a touch screen and allows the user to provide one or more inputs for interacting with the watch body 1220.

In some embodiments, the watch body 1220 includes one or more sensors 1221. The sensors 1221 of the watch body 1220 can be the same or distinct from the sensors 1213 of the wearable band 1210. The sensors 1221 of the watch body 1220 can be distributed on an inside and/or an outside surface of the watch body 1220. In some embodiments, the sensors 1221 are configured to contact a user's skin when the watch body 1220 is worn by the user. For example, the sensors 1221 can be placed on the bottom side of the watch body 1220 and the coupling mechanism 1216 can be a cradle with an opening that allows the bottom side of the watch body 1220 to directly contact the user's skin. Alternatively, in some embodiments, the watch body 1220 does not include sensors that are configured to contact the user's skin (e.g., including sensors internal and/or external to the watch body 1220 that are configured to sense data of the watch body 1220 and the watch body 1220's surrounding environment). In some embodiments, the sensors 1213 are configured to track a position and/or motion of the watch body 1220.

The watch body 1220 and the wearable band 1210 can share data using a wired communication method (e.g., a Universal Asynchronous Receiver/Transmitter (UART) or a USB transceiver) and/or a wireless communication method (e.g., near-field communication or Bluetooth). For example, the watch body 1220 and the wearable band 1210 can share data sensed by the sensors 1213 and 1221, as well as application- and device-specific information (e.g., active and/or available applications), output devices (e.g., display or speakers), and/or input devices (e.g., touch screens, microphones, or imaging sensors).

In some embodiments, the watch body 1220 can include, without limitation, a front-facing camera 1225a and/or a rear-facing camera 1225b, sensors 1221 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 12B; imaging sensor 1263), a touch sensor, a sweat sensor). In some embodiments, the watch body 1220 can include one or more haptic devices 1276 (FIG. 12B; a vibratory haptic actuator) that is configured to provide haptic feedback (e.g., a cutaneous and/or kinesthetic sensation) to the user. The sensors 1221 and/or the haptic device 1276 can also be configured to operate in conjunction with multiple applications, including, without limitation, health-monitoring applications, social media applications, game applications, and AR applications (e.g., the applications associated with AR).

As described above, the watch body 1220 and the wearable band 1210, when coupled, can form the wrist-wearable device 1100. When coupled, the watch body 1220 and wearable band 1210 operate as a single device to execute functions (e.g., operations, detections, or communications) described herein. In some embodiments, each device is provided with particular instructions for performing the one or more operations of the wrist-wearable device 1100. For example, in accordance with a determination that the watch body 1220 does not include neuromuscular-signal sensors, the wearable band 1210 can include alternative instructions for performing associated instructions (e.g., providing sensed neuromuscular-signal data to the watch body 1220 via a different electronic device). Operations of the wrist-wearable device 1100 can be performed by the watch body 1220 alone or in conjunction with the wearable band 1210 (e.g., via respective processors and/or hardware components) and vice versa. In some embodiments, operations of the wrist-wearable device 1100, the watch body 1220, and/or the wearable band 1210 can be performed in conjunction with one or more processors and/or hardware components of another communicatively coupled device (e.g., FIGS. 14A and 14B; the HIPD 1300).

As described below with reference to the block diagram of FIG. 12B, the wearable band 1210 and/or the watch body 1220 can each include independent resources required to independently execute functions. For example, the wearable band 1210 and/or the watch body 1220 can each include a power source (e.g., a battery), a memory, data storage, a processor (e.g., a CPU), communications, a light source, and/or input/output devices.

FIG. 12B shows block diagrams of a computing system 1230 corresponding to the wearable band 1210 and a computing system 1260 corresponding to the watch body 1220, according to some embodiments. A computing system of the wrist-wearable device 1100 includes a combination of components of the wearable band computing system 1230 and the watch body computing system 1260, in accordance with some embodiments.

The watch body 1220 and/or the wearable band 1210 can include one or more components shown in watch body computing system 1260. In some embodiments, a single integrated circuit includes all or a substantial portion of the components of the watch body computing system 1260 that are included in a single integrated circuit. Alternatively, in some embodiments, components of the watch body computing system 1260 are included in a plurality of integrated circuits that are communicatively coupled. In some embodiments, the watch body computing system 1260 is configured to couple (e.g., via a wired or wireless connection) with the wearable band computing system 1230, which allows the computing systems to share components, distribute tasks, and/or perform other operations described herein (individually or as a single device).

The watch body computing system 1260 can include one or more processors 1279, a controller 1277, a peripherals interface 1261, a power system 1295, and memory (e.g., a memory 1280), each of which are defined above and described in more detail below.

The power system 1295 can include a charger input 1296, a power-management integrated circuit (PMIC) 1297, and a battery 1298, each of which are defined above. In some embodiments, a watch body 1220 and a wearable band 1210 can have respective charger inputs (e.g., charger inputs 1296 and 1257), respective batteries (e.g., batteries 1298 and 1259), and can share power with each other (e.g., the watch body 1220 can power and/or charge the wearable band 1210 and vice versa). Although watch body 1220 and/or the wearable band 1210 can include respective charger inputs, a single charger input can charge both devices when coupled. The watch body 1220 and the wearable band 1210 can receive a charge using a variety of techniques. In some embodiments, the watch body 1220 and the wearable band 1210 can use a wired charging assembly (e.g., power cords) to receive the charge. Alternatively, or in addition, the watch body 1220 and/or the wearable band 1210 can be configured for wireless charging. For example, a portable charging device can be designed to mate with a portion of watch body 1220 and/or wearable band 1210 and wirelessly deliver usable power to a battery of watch body 1220 and/or wearable band 1210. The watch body 1220 and the wearable band 1210 can have independent power systems (e.g., power system 1295 and 1256) to enable each to operate independently. The watch body 1220 and wearable band 1210 can also share power (e.g., one can charge the other) via respective PMICs (e.g., PMICs 1297 and 1258) that can share power over power and ground conductors and/or over wireless charging antennas.

In some embodiments, the peripherals interface 1261 can include one or more sensors 1221, many of which listed below are defined above. The sensors 1221 can include one or more coupling sensors 1262 for detecting when the watch body 1220 is coupled with another electronic device (e.g., a wearable band 1210). The sensors 1221 can include imaging sensors 1263 (one or more of the cameras 1225 and/or separate imaging sensors 1263 (e.g., thermal-imaging sensors)). In some embodiments, the sensors 1221 include one or more SpO2 sensors 1264. In some embodiments, the sensors 1221 include one or more biopotential-signal sensors (e.g., EMG sensors 1265, which may be disposed on a user-facing portion of the watch body 1220 and/or the wearable band 1210). In some embodiments, the sensors 1221 include one or more capacitive sensors 1266. In some embodiments, the sensors 1221 include one or more heart rate sensors 1267. In some embodiments, the sensors 1221 include one or more IMUs 1268. In some embodiments, one or more IMUs 1268 can be configured to detect movement of a user's hand or other location that the watch body 1220 is placed or held.

In some embodiments, the peripherals interface 1261 includes an NFC component 1269, a GPS component 1270, a long-term evolution (LTE) component 1271, and/or a Wi-Fi and/or Bluetooth communication component 1272. In some embodiments, the peripherals interface 1261 includes one or more buttons 1273 (e.g., the peripheral buttons 1223 and 1227 in FIG. 12A), which, when selected by a user, cause operations to be performed at the watch body 1220. In some embodiments, the peripherals interface 1261 includes one or more indicators, such as a light-emitting diode (LED), to provide a user with visual indicators (e.g., message received, low battery, an active microphone, and/or a camera).

The watch body 1220 can include at least one display 1205 for displaying visual representations of information or data to the user, including user-interface elements and/or three-dimensional (3D) virtual objects. The display can also include a touch screen for inputting user inputs, such as touch gestures, swipe gestures, and the like. The watch body 1220 can include at least one speaker 1274 and at least one microphone 1275 for providing audio signals to the user and receiving audio input from the user. The user can provide user inputs through the microphone 1275 and can also receive audio output from the speaker 1274 as part of a haptic event provided by the haptic controller 1278. The watch body 1220 can include at least one camera 1225, including a front-facing camera 1225a and a rear-facing camera 1225b. The cameras 1225 can include ultra-wide-angle cameras, wide-angle cameras, fish-eye cameras, spherical cameras, telephoto cameras, depth-sensing cameras, or other types of cameras.

The watch body computing system 1260 can include one or more haptic controllers 1278 and associated componentry (e.g., haptic devices 1276) for providing haptic events at the watch body 1220 (e.g., a vibrating sensation or audio output in response to an event at the watch body 1220). The haptic controllers 1278 can communicate with one or more haptic devices 1276, such as electroacoustic devices, including a speaker of the one or more speakers 1274 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1278 can provide haptic events to respective haptic actuators that are capable of being sensed by a user of the watch body 1220. In some embodiments, the one or more haptic controllers 1278 can receive input signals from an application of the applications 1282.

In some embodiments, the computer system 1230 and/or the computer system 1260 can include memory 1280, which can be controlled by a memory controller of the one or more controllers 1277 and/or one or more processors 1279. In some embodiments, software components stored in the memory 1280 include one or more applications 1282 configured to perform operations at the watch body 1220. In some embodiments, the one or more applications 1282 include games, word processors, messaging applications, calling applications, web browsers, social media applications, media streaming applications, financial applications, calendars, clocks, etc. In some embodiments, software components stored in the memory 1280 include one or more communication interface modules 1283 as defined above. In some embodiments, software components stored in the memory 1280 include one or more graphics modules 1284 for rendering, encoding, and/or decoding audio and/or visual data; and one or more data management modules 1285 for collecting, organizing, and/or providing access to the data 1287 stored in memory 1280. In some embodiments, software components stored in the memory 1280 are configured to perform the features described above in reference to FIGS. 1A-9B. In some embodiments, one or more of applications 1282 and/or one or more modules can work in conjunction with one another to perform various tasks at the watch body 1220.

In some embodiments, software components stored in the memory 1280 can include one or more operating systems 1281 (e.g., a Linux-based operating system, an Android operating system, etc.). The memory 1280 can also include data 1287. The data 1287 can include profile data 1288A, sensor data 1289A, media content data 1290, application data 1291, and which stores data related to the performance of the features described above in reference to FIGS. 1A-9B.

It should be appreciated that the watch body computing system 1260 is an example of a computing system within the watch body 1220, and that the watch body 1220 can have more or fewer components than shown in the watch body computing system 1260, combine two or more components, and/or have a different configuration and/or arrangement of the components. The various components shown in watch body computing system 1260 are implemented in hardware, software, firmware, or a combination thereof, including one or more signal processing and/or application-specific integrated circuits.

Turning to the wearable band computing system 1230, one or more components that can be included in the wearable band 1210 are shown. The wearable band computing system 1230 can include more or fewer components than shown in the watch body computing system 1260, combine two or more components, and/or have a different configuration and/or arrangement of some or all of the components. In some embodiments, all, or a substantial portion of the components of the wearable band computing system 1230 are included in a single integrated circuit. Alternatively, in some embodiments, components of the wearable band computing system 1230 are included in a plurality of integrated circuits that are communicatively coupled. As described above, in some embodiments, the wearable band computing system 1230 is configured to couple (e.g., via a wired or wireless connection) with the watch body computing system 1260, which allows the computing systems to share components, distribute tasks, and/or perform other operations described herein (individually or as a single device).

The wearable band computing system 1230, similar to the watch body computing system 1260, can include one or more processors 1249, one or more controllers 1247 (including one or more haptics controller 1248), a peripherals interface 1231 that can include one or more sensors 1213 and other peripheral devices, power source (e.g., a power system 1256), and memory (e.g., a memory 1250) that includes an operating system (e.g., an operating system 1251), data (e.g., data 1254 including profile data 1288B, sensor data 1289B, etc.), and one or more modules (e.g., a communications interface module 1252, a data management module 1253, etc.).

The one or more sensors 1213 can be analogous to sensors 1221 of the computer system 1260 in light of the definitions above. For example, sensors 1213 can include one or more coupling sensors 1232, one or more SpO2 sensors 1234, one or more EMG sensors 1235, one or more capacitive sensors 1236, one or more heart rate sensors 1237, and one or more IMU sensors 1238.

The peripherals interface 1231 can also include other components analogous to those included in the peripheral interface 1261 of the computer system 1260, including an NFC component 1239, a GPS component 1240, an LTE component 1241, a Wi-Fi and/or Bluetooth communication component 1242, and/or one or more haptic devices 1276 as described above in reference to peripherals interface 1261. In some embodiments, the peripherals interface 1231 includes one or more buttons 1243, a display 1233, a speaker 1244, a microphone 1245, and a camera 1255. In some embodiments, the peripherals interface 1231 includes one or more indicators, such as an LED.

It should be appreciated that the wearable band computing system 1230 is an example of a computing system within the wearable band 1210, and that the wearable band 1210 can have more or fewer components than shown in the wearable band computing system 1230, combine two or more components, and/or have a different configuration and/or arrangement of the components. The various components shown in wearable band computing system 1230 can be implemented in one or a combination of hardware, software, and firmware, including one or more signal processing and/or application-specific integrated circuits.

The wrist-wearable device 1100 with respect to FIG. 12A is an example of the wearable band 1210 and the watch body 1220 coupled, so the wrist-wearable device 1100 will be understood to include the components shown and described for the wearable band computing system 1230 and the watch body computing system 1260. In some embodiments, wrist-wearable device 1100 has a split architecture (e.g., a split mechanical architecture or a split electrical architecture) between the watch body 1220 and the wearable band 1210. In other words, all of the components shown in the wearable band computing system 1230 and the watch body computing system 1260 can be housed or otherwise disposed in a combined watch device 1100, or within individual components of the watch body 1220, wearable band 1210, and/or portions thereof (e.g., a coupling mechanism 1216 of the wearable band 1210).

The techniques described above can be used with any device for sensing neuromuscular signals, including the arm-wearable devices of FIG. 12A-12B, but could also be used with other types of wearable devices for sensing neuromuscular signals (such as body-wearable or head-wearable devices that might have neuromuscular sensors closer to the brain or spinal column).

In some embodiments, a wrist-wearable device 1100 can be used in conjunction with a head-wearable device described below (e.g., AR device 1200 and VR device 1310) and/or an HIPD 1300, and the wrist-wearable device 1100 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 1200 and VR device 1310.

### Example Head-Wearable Devices

FIGS. 13A, 13B-1, 13B-2, and 13C show example head-wearable devices, in accordance with some embodiments. Head-wearable devices can include, but are not limited to, AR devices 1200 (e.g., AR or smart eyewear devices, such as smart glasses, smart monocles, smart contacts, etc.), VR devices 1310 (e.g., VR headsets or head-mounted displays (HMDs)), or other ocularly coupled devices. The AR devices 1200 and the VR devices 1310 are instances of the head-wearable devices worn by the user while they are selecting objects using a combination of gaze rays and controller rays described in reference to FIGS. 1A-4B and 8A-8D herein, such that the head-wearable device should be understood to have the features of the AR devices 1200 and/or the VR devices 1310 and vice versa. The AR devices 1200 and the VR devices 1310 can perform various functions and/or operations associated with navigating through user interfaces and selectively opening applications, as well as the functions and/or operations described above with reference to FIGS. 1A-4B and 8A-8D.

In some embodiments, an XR system (e.g., FIGS. 11A-11C-2; AR systems 1100a-1100c-2) includes an AR device 1200 (as shown in FIG. 13A) and/or VR device 1310 (as shown in FIGS. 13B-1-B-2). In some embodiments, the AR device 1200 and the VR device 1310 can include one or more analogous components (e.g., components for presenting interactive AR environments, such as processors, memory, and/or presentation devices, including one or more displays and/or one or more waveguides), some of which are described in more detail with respect to FIG. 13C. The head-wearable devices can use display projectors (e.g., display projector assemblies 1307A and 1307B) and/or waveguides for projecting representations of data to a user. Some embodiments of head-wearable devices do not include displays.

FIG. 13A shows an example visual depiction of the AR device 1200 (e.g., which may also be described herein as augmented-reality glasses and/or smart glasses). The AR device 1200 can work in conjunction with additional electronic components that are not shown in FIGS. 13A, such as a wearable accessory device and/or an intermediary processing device, in electronic communication or otherwise configured to be used in conjunction with the AR device 1200. In some embodiments, the wearable accessory device and/or the intermediary processing device may be configured to couple with the AR device 1200 via a coupling mechanism in electronic communication with a coupling sensor 1324, where the coupling sensor 1324 can detect when an electronic device becomes physically or electronically coupled with the AR device 1200. In some embodiments, the AR device 1200 can be configured to couple to a housing (e.g., a portion of frame 1304 or temple arms 1305), which may include one or more additional coupling mechanisms configured to couple with additional accessory devices. The components shown in FIG. 13A can be implemented in hardware, software, firmware, or a combination thereof, including one or more signal-processing components and/or application-specific integrated circuits (ASICs).

The AR device 1200 includes mechanical glasses components, including a frame 1304 configured to hold one or more lenses (e.g., one or both lenses 1306-1 and 1306-2). One of ordinary skill in the art will appreciate that the AR device 1200 can include additional mechanical components, such as hinges configured to allow portions of the frame 1304 of the AR device 1200 to be folded and unfolded, a bridge configured to span the gap between the lenses 1306-1 and 1306-2 and rest on the user's nose, nose pads configured to rest on the bridge of the nose and provide support for the AR device 1200, earpieces configured to rest on the user's ears and provide additional support for the AR device 1200, temple arms 1305 configured to extend from the hinges to the earpieces of the AR device 1200, and the like. One of ordinary skill in the art will further appreciate that some examples of the AR device 1200 can include none of the mechanical components described herein. For example, smart contact lenses configured to present AR to users may not include any components of the AR device 1200.

The lenses 1306-1 and 1306-2 can be individual displays or display devices (e.g., a waveguide for projected representations). The lenses 1306-1 and 1306-2 may act together or independently to present an image or series of images to a user. In some embodiments, the lenses 1306-1 and 1306-2 can operate in conjunction with one or more display projector assemblies 1307A and 1307B to present image data to a user. While the AR device 1200 includes two displays, embodiments of this disclosure may be implemented in AR devices with a single near-eye display (NED) or more than two NEDs.

The AR device 1200 includes electronic components, many of which will be described in more detail below with respect to FIG. 13C. Some example electronic components are illustrated in FIG. 13A, including sensors 1323-1, 1323-2, 1323-3, 1323-4, 1323-5, and 1323-6, which can be distributed along a substantial portion of the frame 1304 of the AR device 1200. The different types of sensors are described below in reference to FIG. 13C. The AR device 1200 also includes a left camera 1339A and a right camera 1339B, which are located on different sides of the frame 1304. And the eyewear device includes one or more processors 1348A and 1348B (e.g., an integral microprocessor, such as an ASIC) that is embedded into a portion of the frame 1304.

FIGS. 13B-1 and 13B-2 show an example visual depiction of the VR device 1310 (e.g., a head-mounted display (HMD) 1312, also referred to herein as an AR headset, a head-wearable device, or a VR headset). The HMD 1312 includes a front body 1314 and a frame 1316 (e.g., a strap or band) shaped to fit around a user's head. In some embodiments, the front body 1314 and/or the frame 1316 includes one or more electronic elements for facilitating presentation of and/or interactions with an AR and/or VR system (e.g., displays, processors (e.g., processor 1348A-1), IMUs, tracking emitters or detectors, or sensors). In some embodiments, the HMD 1312 includes output audio transducers (e.g., an audio transducer 1318-1), as shown in FIG. 13B-2. In some embodiments, one or more components, such as the output audio transducer(s) 1318 and the frame 1316, can be configured to attach and detach (e.g., are detachably attachable) to the HMD 1312 (e.g., a portion or all of the frame 1316 and/or the output audio transducer 1318), as shown in FIG. 13B-2. In some embodiments, coupling a detachable component to the HMD 1312 causes the detachable component to come into electronic communication with the HMD 1312. The VR device 1310 includes electronic components, many of which will be described in more detail below with respect to FIG. 13C.

FIGS. 13B-1 and 13B-2 also show that the VR device 1310 having one or more cameras, such as the left camera 1339A and the right camera 1339B, which can be analogous to the left and right cameras on the frame 1304 of the AR device 1200. In some embodiments, the VR device 1310 includes one or more additional cameras (e.g., cameras 1339C and 1339D), which can be configured to augment image data obtained by the cameras 1339A and 1339B by providing more information. For example, the camera 1339C can be used to supply color information that is not discerned by cameras 1339A and 1339B. In some embodiments, one or more of the cameras 1339A to 1339D can include an optional IR (infrared) cut filter configured to remove IR light from being received at the respective camera sensors.

The VR device 1310 can include a housing 1390 storing one or more components of the VR device 1310 and/or additional components of the VR device 1310. The housing 1390 can be a modular electronic device configured to couple with the VR device 1310 (or an AR device 1200) and supplement and/or extend the capabilities of the VR device 1310 (or an AR device 1200). For example, the housing 1390 can include additional sensors, cameras, power sources, and processors (e.g., processor 1348A-2). To improve and/or increase the functionality of the VR device 1310. Examples of the different components included in the housing 1390 are described below in reference to FIG. 13C.

Alternatively, or in addition, in some embodiments, the head-wearable device, such as the VR device 1310 and/or the AR device 1200, includes, or is communicatively coupled to, another external device (e.g., a paired device), such as an HIPD 1300 (discussed below in reference to FIGS. 14A and 14B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 1300, an optional neckband, and/or a wearable accessory device) with the head-wearable devices (e.g., an AR device 1200 and/or a VR device 1310) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 1300) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 1300, can process information generated by one or more of its sensors and/or information provided by other communicatively coupled devices. For example, a head-wearable device can include an IMU, and the intermediary processing device (a neckband and/or an HIPD 1300) can compute all inertial and spatial calculations from the IMUs located on the head-wearable device. Additional examples of processing performed by a communicatively coupled device, such as the HIPD 1300, are provided below in reference to FIGS. 14A and 14B.

AR systems may include a variety of types of visual feedback mechanisms. For example, display devices in the AR devices 1200 and/or the VR devices 1310 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 1200 and/or the VR device 1310 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1200 and the VR device 1310, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 1200 and/or the VR device 1310 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 1100, an HIPD 1300, and/or other devices described herein.

FIG. 13C illustrates a computing system 1320 and an optional housing 1390, each of which shows components that can be included in a head-wearable device (e.g., the AR device 1200 and/or the VR device 1310). In some embodiments, more or fewer components can be included in the optional housing 1390 depending on practical restraints of the respective head-wearable device being described. Additionally or alternatively, the optional housing 1390 can include additional components to expand and/or augment the functionality of a head-wearable device.

In some embodiments, the computing system 1320 and/or the optional housing 1390 can include one or more peripheral interfaces 1322A and 1322B, one or more power systems 1342A and 1342B (including charger input 1343, PMIC 1344, and battery 1345), one or more controllers 1346A and 1346B (including one or more haptic controllers 1347), one or more processors 1348A and 1348B (as defined above, including any of the examples provided), and memory 1350A and 1350B, which can all be in electronic communication with each other. For example, the one or more processors 1348A and/or 1348B can be configured to execute instructions stored in the memory 1350A and/or 1350B, which can cause a controller of the one or more controllers 1346A and/or 1346B to cause operations to be performed at one or more peripheral devices of the peripherals interfaces 1322A and/or 1322B. In some embodiments, each operation described can occur based on electrical power provided by the power system 1342A and/or 1342B.

In some embodiments, the peripherals interface 1322A can include one or more devices configured to be part of the computing system 1320, many of which have been defined above and/or described with respect to wrist-wearable devices shown in FIGS. 12A and 12B. For example, the peripherals interface can include one or more sensors 1323A. Some example sensors include one or more coupling sensors 1324, one or more acoustic sensors 1325, one or more imaging sensors 1326, one or more EMG sensors 1327, one or more capacitive sensors 1328, and/or one or more IMUs 1329. In some embodiments, the sensors 1323A further include depth sensors 1367, light sensors 1368, and/or any other types of sensors defined above or described with respect to any other embodiments discussed herein.

In some embodiments, the peripherals interface can include one or more additional peripheral devices, including one or more NFC devices 1330, one or more GPS devices 1331, one or more LTE devices 1332, one or more Wi-Fi and/or Bluetooth devices 1333, one or more buttons 1334 (e.g., including buttons that are slidable or otherwise adjustable), one or more displays 1335A, one or more speakers 1336A, one or more microphones 1337A, one or more cameras 1338A (e.g., including the first camera 1339-1 through nth camera 1339-n, which are analogous to the left camera 1339A and/or the right camera 1339B), one or more haptic devices 1340, and/or any other types of peripheral devices defined above or described with respect to any other embodiments discussed herein.

The head-wearable devices can include a variety of types of visual feedback mechanisms (e.g., presentation devices). For example, display devices in the AR device 1200 and/or the VR device 1310 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1335A can be coupled to each of the lenses 1306-1 and 1306-2 of the AR device 1200. The displays 1335A coupled to each of the lenses 1306-1 and 1306-2 can act together or independently to present an image or series of images to a user. In some embodiments, the AR device 1200 and/or the VR device 1310 includes a single display 1335A (e.g., a near-eye display) or more than two displays 1335A.

In some embodiments, a first set of one or more displays 1335A can be used to present an augmented-reality environment, and a second set of one or more display devices 1335A can be used to present a VR environment. In some embodiments, one or more waveguides are used in conjunction with presenting AR content to the user of the AR device 1200 and/or the VR device 1310 (e.g., as a means of delivering light from a display projector assembly and/or one or more displays 1335A to the user's eyes). In some embodiments, one or more waveguides are fully or partially integrated into the AR device 1200 and/or the VR device 1310. Additionally, or alternatively, to display screens, some AR systems include one or more projection systems. For example, display devices in the AR device 1200 and/or the VR device 1310 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 1335A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 1335A for presenting information to users. For example, an external display 1335A can be used to show a current battery level, network activity (e.g., connected, disconnected), current activity (e.g., playing a game, in a call, in a meeting, or watching a movie), and/or other relevant information. In some embodiments, the external displays 1335A can be used to communicate with others. For example, a user of the head-wearable device can cause the external displays 1335A to present a “do not disturb” notification. The external displays 1335A can also be used by the user to share any information captured by the one or more components of the peripherals interface 1322A and/or generated by the head-wearable device (e.g., during operation and/or performance of one or more applications).

The memory 1350A can include instructions and/or data executable by one or more processors 1348A (and/or processors 1348B of the housing 1390) and/or a memory controller of the one or more controllers 1346A (and/or controller 1346B of the housing 1390). The memory 1350A can include one or more operating systems 1351, one or more applications 1352, one or more communication interface modules 1353A, one or more graphics modules 1354A, one or more AR processing modules 1355A, gaze ray processing module 1356A, controller ray processing module 1357A, ray intersection processing module, and/or any other types of modules or components defined above or described with respect to any other embodiments discussed herein.

The data 1360 stored in memory 1350A can be used in conjunction with one or more of the applications and/or programs discussed above. The data 1360 can include profile data 1361, sensor data 1362, media content data 1363, AR application data 1364, and/or any other types of data defined above or described with respect to any other embodiments discussed herein.

In some embodiments, the controller 1346A of the head-wearable devices processes information generated by the sensors 1323A on the head-wearable devices and/or another component of the head-wearable devices and/or communicatively coupled with the head-wearable devices (e.g., components of the housing 1390, such as components of peripherals interface 1322B). For example, the controller 1346A can process information from the acoustic sensors 1325 and/or image sensors 1326. For each detected sound, the controller 1346A can perform a direction of arrival (DOA) estimation to estimate a direction from which the detected sound arrived at a head-wearable device. As one or more of the acoustic sensors 1325 detect sounds, the controller 1346A can populate an audio data set with the information (e.g., represented by sensor data 1362).

In some embodiments, a physical electronic connector can convey information between the head-wearable devices and another electronic device, and/or between one or more processors 1348A of the head-wearable devices and the controller 1346A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1300) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 1200 and/or the VR device 1310 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 13B-1 and 13B-2 show the VR device 1310 having cameras 1339A-1339D, which can be used to provide depth information for creating a voxel field and a 2D mesh to provide object information to the user to avoid collisions.

The optional housing 1390 can include analogous components to those describe above with respect to the computing system 1320. For example, the optional housing 1390 can include a respective peripherals interface 1322B, including more or fewer components to those described above with respect to the peripherals interface 1322A. As described above, the components of the optional housing 1390 can be used to augment and/or expand on the functionality of the head-wearable devices. For example, the optional housing 1390 can include respective sensors 1323B, speakers 1336B, displays 1335B, microphones 1337B, cameras 1338B, and/or other components to capture and/or present data. Similarly, the optional housing 1390 can include one or more processors 1348B, controllers 1346B, and/or memory 1350B (including respective communication interface modules 1353B, one or more graphics modules 1354B, one or more AR processing modules 1355B) that can be used individually and/or in conjunction with the components of the computing system 1320.

The techniques described above in FIGS. 13A-13C can be used with different head-wearable devices. In some embodiments, the head-wearable devices (e.g., the AR device 1200 and/or the VR device 1310) can be used in conjunction with one or more wearable devices such as a wrist-wearable device 1100 (or components thereof). Having thus described example the head-wearable devices, attention will now be turned to example handheld intermediary processing devices, such as HIPD 1300.

### Example Handheld Intermediary Processing Devices

FIGS. 14A and 14B illustrate an example handheld intermediary processing device (HIPD) 1300, in accordance with some embodiments. The HIPD 1300 is an instance of the handheld device as described in reference to FIGS. 1A-4B and 8A-8D herein, such that the HIPD 1300 should be understood to have the features described with respect to any intermediary device defined above or otherwise described herein, and vice versa. The HIPD 1300 can perform various functions and/or operations associated with navigating through user interfaces and selectively opening applications, as well as the functions and/or operations described above with reference to FIGS. 1A-4B and 8A-8D.

FIG. 14A shows a top view 1405 and a side view 1425 of the HIPD 1300. The HIPD 1300 is configured to communicatively couple with one or more wearable devices (or other electronic devices) associated with a user. For example, the HIPD 1300 is configured to communicatively couple with a user's wrist-wearable device 1100 (or components thereof, such as the watch body 1220 and the wearable band 1110), AR device 1200, and/or VR device 1310. The HIPD 1300 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 1300 can successfully be communicatively coupled with an electronic device, such as a wearable device).

The HIPD 1300 can perform various functions independently and/or in conjunction with one or more wearable devices (e.g., wrist-wearable device 1100, AR device 1200, and/or VR device 1310). The HIPD 1300 is configured to increase and/or improve the functionality of communicatively coupled devices, such as the wearable devices. The HIPD 1300 is configured to perform one or more functions or operations associated with interacting with user interfaces and applications of communicatively coupled devices, interacting with an AR environment, interacting with a VR environment, and/or operating as a human-machine interface controller, as well as functions and/or operations described above with reference to FIGS. 1A-4B and 8A-8D. Additionally, as will be described in more detail below, functionality and/or operations of the HIPD 1300 can include, without limitation, task offloading and/or handoffs, thermals offloading and/or handoffs, 6 degrees of freedom (6DoF) raycasting and/or gaming (e.g., using imaging devices or cameras 1414A and 1414B, which can be used for simultaneous localization and mapping (SLAM), and/or with other image processing techniques), portable charging; messaging, image capturing via one or more imaging devices or cameras (e.g., cameras 1422A and 1422B), sensing user input (e.g., sensing a touch on a multitouch input surface 1402), wireless communications and/or interlining (e.g., cellular, near field, Wi-Fi, or personal area network), location determination, financial transactions, providing haptic feedback, alarms, notifications, biometric authentication, health monitoring, sleep monitoring. The above-example functions can be executed independently in the HIPD 1300 and/or in communication between the HIPD 1300 and another wearable device described herein. In some embodiments, functions can be executed on the HIPD 1300 in conjunction with an AR environment. As the skilled artisan will appreciate upon reading the descriptions provided herein, the novel HIPD 1300 described herein can be used with any type of suitable AR environment.

While the HIPD 1300 is communicatively coupled with a wearable device and/or other electronic device, the HIPD 1300 is configured to perform one or more operations initiated at the wearable device and/or the other electronic device. In particular, one or more operations of the wearable device and/or the other electronic device can be offloaded to the HIPD 1300 to be performed. The HIPD 1300 performs one or more operations of the wearable device and/or the other electronic device and provides data corresponding to the completed operations to the wearable device and/or the other electronic device. For example, a user can initiate a video stream using the AR device 1200 and back-end tasks associated with performing the video stream (e.g., video rendering) can be offloaded to the HIPD 1300, which the HIPD 1300 performs and provides corresponding data to the AR device 1200 to perform remaining front-end tasks associated with the video stream (e.g., presenting the rendered video data via a display of the AR device 1200). In this way, the HIPD 1300, which has more computational resources and greater thermal headroom than a wearable device can perform computationally intensive tasks for the wearable device, improving performance of an operation performed by the wearable device.

The HIPD 1300 includes a multi-touch input surface 1402 on a first side (e.g., a front surface) that is configured to detect one or more user inputs. In particular, the multi-touch input surface 1402 can detect single-tap inputs, multi-tap inputs, swipe gestures and/or inputs, force-based and/or pressure-based touch inputs, held taps, and the like. The multi-touch input surface 1402 is configured to detect capacitive touch inputs and/or force (and/or pressure) touch inputs. The multi-touch input surface 1402 includes a first touch-input surface 1404 defined by a surface depression, and a second touch-input surface 1406 defined by a substantially planar portion. The first touch-input surface 1404 can be disposed adjacent to the second touch-input surface 1406. In some embodiments, the first touch-input surface 1404 and the second touch-input surface 1406 can be different dimensions, shapes, and/or cover different portions of the multi-touch input surface 1402. For example, the first touch-input surface 1404 can be substantially circular and the second touch-input surface 1406 is substantially rectangular. In some embodiments, the surface depression of the multi-touch input surface 1402 is configured to guide user handling of the HIPD 1300. In particular, the surface depression is configured such that the user holds the HIPD 1300 upright when held in a single hand (e.g., such that the using imaging devices or cameras 1414A and 1414B are pointed toward a ceiling or the sky). Additionally, the surface depression is configured such that the user's thumb rests within the first touch-input surface 1404.

In some embodiments, the different touch-input surfaces includes a plurality of touch-input zones. For example, the second touch-input surface 1406 includes at least a first touch-input zone 1408 within a second touch-input zone 1406 and a third touch-input zone 1410 within the first touch-input zone 1408. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1408 causes the HIPD 1300 to perform a first command and a user input detected within the second touch-input zone 1406 causes the HIPD 1300 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1408 can be configured to detect force touch inputs (e.g., a magnitude at which the user presses down) and capacitive touch inputs, and the second touch-input zone 1406 can be configured to detect capacitive touch inputs.

The HIPD 1300 includes one or more sensors 1451 for sensing data used in the performance of one or more operations and/or functions. For example, the HIPD 1300 can include an IMU that is used in conjunction with cameras 1414 for 3-dimensional object manipulation (e.g., enlarging, moving, destroying, etc. an object) in an AR or VR environment. Non-limiting examples of the sensors 1451 included in the HIPD 1300 include a light sensor, a magnetometer, a depth sensor, a pressure sensor, and a force sensor. Additional examples of the sensors 1451 are provided below in reference to FIG. 14B.

The HIPD 1300 can include one or more light indicators 1412 to provide one or more notifications to the user. In some embodiments, the light indicators are LEDs or other types of illumination devices. The light indicators 1412 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1404. The light indicators can be illuminated in different colors and/or patterns to provide the user with one or more notifications and/or information about the device. For example, a light indicator positioned around the first touch-input surface 1404 can flash when the user receives a notification (e.g., a message), change red when the HIPD 1300 is out of power, operate as a progress bar (e.g., a light ring that is closed when a task is completed (e.g., 0% to 100%)), operates as a volume indicator, etc.).

In some embodiments, the HIPD 1300 includes one or more additional sensors on another surface. For example, as shown FIG. 14A, HIPD 1300 includes a set of one or more sensors (e.g., sensor set 1420) on an edge of the HIPD 1300. The sensor set 1420, when positioned on an edge of the of the HIPD 1300, can be pe positioned at a predetermined tilt angle (e.g., 26 degrees), which allows the sensor set 1420 to be angled toward the user when placed on a desk or other flat surface. Alternatively, in some embodiments, the sensor set 1420 is positioned on a surface opposite the multi-touch input surface 1402 (e.g., a back surface). The one or more sensors of the sensor set 1420 are discussed in detail below.

The side view 1425 of the of the HIPD 1300 shows the sensor set 1420 and camera 1414B. The sensor set 1420 includes one or more cameras 1422A and 1422B, a depth projector 1424, an ambient light sensor 1428, and a depth receiver 1430. In some embodiments, the sensor set 1420 includes a light indicator 1426. The light indicator 1426 can operate as a privacy indicator to let the user and/or those around them know that a camera and/or microphone is active. The sensor set 1420 is configured to capture a user's facial expression such that the user can puppet a custom avatar (e.g., showing emotions, such as smiles, laughter, etc., on the avatar or a digital representation of the user). The sensor set 1420 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 1300 described herein can use different sensor set 1420 configurations and/or sensor set 1420 placement.

In some embodiments, the HIPD 1300 includes one or more haptic devices 1471 (FIG. 14B; e.g., a vibratory haptic actuator) that are configured to provide haptic feedback (e.g., kinesthetic sensation). The sensors 1451, and/or the haptic devices 1471 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1300 is configured to operate without a display. However, in optional embodiments, the HIPD 1300 can include a display 1468 (FIG. 13B). The HIPD 1300 can also income one or more optional peripheral buttons 1467 (FIG. 14B). For example, the peripheral buttons 1467 can be used to turn on or turn off the HIPD 1300. Further, the HIPD 1300 housing can be formed of polymers and/or elastomer elastomers. The HIPD 1300 can be configured to have a non-slip surface to allow the HIPD 1300 to be placed on a surface without requiring a user to watch over the HIPD 1300. In other words, the HIPD 1300 is designed such that it would not easily slide off a surfaces. In some embodiments, the HIPD 1300 include one or magnets to couple the HIPD 1300 to another surface. This allows the user to mount the HIPD 1300 to different surfaces and provide the user with greater flexibility in use of the HIPD 1300.

As described above, the HIPD 1300 can distribute and/or provide instructions for performing the one or more tasks at the HIPD 1300 and/or a communicatively coupled device. For example, the HIPD 1300 can identify one or more back-end tasks to be performed by the HIPD 1300 and one or more front-end tasks to be performed by a communicatively coupled device. While the HIPD 1300 is configured to offload and/or handoff tasks of a communicatively coupled device, the HIPD 1300 can perform both back-end and front-end tasks (e.g., via one or more processors, such as CPU 1477; FIG. 14B). The HIPD 1300 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1300 can perform the above operations alone or in conjunction with a wearable device (or other communicatively coupled electronic device).

FIG. 14B shows block diagrams of a computing system 1440 of the HIPD 1300, in accordance with some embodiments. The HIPD 1300, described in detail above, can include one or more components shown in HIPD computing system 1440. The HIPD 1300 will be understood to include the components shown and described below for the HIPD computing system 1440. In some embodiments, all, or a substantial portion of the components of the HIPD computing system 1440 are included in a single integrated circuit. Alternatively, in some embodiments, components of the HIPD computing system 1440 are included in a plurality of integrated circuits that are communicatively coupled.

The HIPD computing system 1440 can include a processor (e.g., a CPU 1477, a GPU, and/or a CPU with integrated graphics), a controller 1475, a peripherals interface 1450 that includes one or more sensors 1451 and other peripheral devices, a power source (e.g., a power system 1495), and memory (e.g., a memory 1478) that includes an operating system (e.g., an operating system 1479), data (e.g., data 1488), one or more applications (e.g., applications 1480), and one or more modules (e.g., a communications interface module 1481, a graphics module 1482, a task and processing management module 1483, an interoperability module 1484, an AR processing module 1485, a data management module 1486, etc.). The HIPD computing system 1440 further includes a power system 1495 that includes a charger input and output 1496, a PMIC 1497, and a battery 1498, all of which are defined above.

In some embodiments, the peripherals interface 1450 can include one or more sensors 1451. The sensors 1451 can include analogous sensors to those described above in reference to FIG. 11B. For example, the sensors 1451 can include imaging sensors 1454, (optional) EMG sensors 1456, IMUs 1458, and capacitive sensors 1460. In some embodiments, the sensors 1451 can include one or more pressure sensor 1452 for sensing pressure data, an altimeter 1453 for sensing an altitude of the HIPD 1400, a magnetometer 1455 for sensing a magnetic field, a depth sensor 1457 (or a time-of flight sensor) for determining a difference between the camera and the subject of an image, a position sensor 1459 (e.g., a flexible position sensor) for sensing a relative displacement or position change of a portion of the HIPD 1300, a force sensor 1461 for sensing a force applied to a portion of the HIPD 1300, and a light sensor 1462 (e.g., an ambient light sensor) for detecting an amount of lighting. The sensors 1451 can include one or more sensors not shown in FIG. 14B.

Analogous to the peripherals described above in reference to FIGS. 11B, the peripherals interface 1450 can also include an NFC component 1463, a GPS component 1464, an LTE component 1465, a Wi-Fi and/or Bluetooth communication component 1466, a speaker 1469, a haptic device 1471, and a microphone 1473. As described above in reference to FIG. 14A, the HIPD 1300 can optionally include a display 1468 and/or one or more buttons 1467. The peripherals interface 1450 can further include one or more cameras 1470, touch surfaces 1472, and/or one or more light emitters 1474. The multi-touch input surface 1402 described above in reference to FIG. 14A is an example of touch surface 1472. The light emitters 1474 can be one or more LEDs, lasers, etc. and can be used to project or present information to a user. For example, the light emitters 1474 can include light indicators 1412 and 1426 described above in reference to FIG. 14A. The cameras 1470 (e.g., cameras 1414A, 1414B, and 1422 described above in FIG. 14A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1470 can be used for SLAM; 6 DoF ray casting, gaming, object manipulation, and/or other rendering; facial recognition and facial expression recognition, etc.

Similar to the watch body computing system 1160 and the watch band computing system 1140 described above in reference to FIG. 11B, the HIPD computing system 1440 can include one or more haptic controllers 1476 and associated componentry (e.g., haptic devices 1471) for providing haptic events at the HIPD 1300.

Memory 1478 can include high-speed random-access memory and/or non-volatile memory, such as one or more magnetic disk storage devices, flash memory devices, or other non-volatile solid-state memory devices. Access to the memory 1478 by other components of the HIPD 1300, such as the one or more processors and the peripherals interface 1450, can be controlled by a memory controller of the controllers 1475.

In some embodiments, software components stored in the memory 1478 include one or more operating systems 1479, one or more applications 1480, one or more communication interface modules 1481, one or more graphics modules 1482, one or more data management modules 1485, which are analogous to the software components described above in reference to FIG. 11B. The software components stored in the memory 1478 are also configured to perform the features described above in reference to FIGS. 1A-9B.

In some embodiments, software components stored in the memory 1478 include a task and processing management module 1483 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1483 uses data 1488 (e.g., device data 1490) to distribute the one or more front-end and/or back-end tasks based on communicatively coupled devices' computing resources, available power, thermal headroom, ongoing operations, and/or other factors. For example, the task and processing management module 1483 can cause the performance of one or more back-end tasks (of an operation performed at communicatively coupled AR device 1200) at the HIPD 1300 in accordance with a determination that the operation is utilizing a predetermined amount (e.g., at least 70%) of computing resources available at the AR device 1200.

In some embodiments, software components stored in the memory 1478 include an interoperability module 1484 for exchanging and utilizing information received and/or provided to distinct communicatively coupled devices. The interoperability module 1484 allows for different systems, devices, and/or applications to connect and communicate in a coordinated way without user input. In some embodiments, software components stored in the memory 1478 include an AR module 1485 that is configured to process signals based at least on sensor data for use in an AR and/or VR environment. For example, the AR processing module 1485 can be used for 3D object manipulation, gesture recognition, facial and facial expression, recognition, etc.

The memory 1478 can also include data 1487, including structured data. In some embodiments, the data 1487 can include profile data 1489, device data 1489 (including device data of one or more devices communicatively coupled with the HIPD 1300, such as device type, hardware, software, configurations, etc.), sensor data 1491, media content data 1492, application data 1493.

It should be appreciated that the HIPD computing system 1440 is an example of a computing system within the HIPD 1300, and that the HIPD 1300 can have more or fewer components than shown in the HIPD computing system 1440, combine two or more components, and/or have a different configuration and/or arrangement of the components. The various components shown in HIPD computing system 1440 are implemented in hardware, software, firmware, or a combination thereof, including one or more signal processing and/or application-specific integrated circuits.

The techniques described above in FIG. 14A-14B can be used with any device used as a human-machine interface controller. In some embodiments, an HIPD 1300 can be used in conjunction with one or more wearable device such as a head-wearable device (e.g., AR device 1200 and VR device 1310) and/or a wrist-wearable device 1100 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by a computing device, cause the computing device to:
while an extended-reality user interface is being presented to a user, the extended-reality user interface includes a plurality of virtual objects available for selection:
receive first data indicating a gaze-based selection ray based on an eye gaze of the user, wherein the gaze-based selection ray passes through a first set of two or more candidate objects of the plurality of virtual objects;
receive second data indicating a controller-based selection ray based on position and orientation of an input controller used by the user to interact with the extended-reality user interface, wherein the controller-based selection ray passes through a second set of two or more candidate objects of the plurality of virtual objects;
determine, based on the first data and the second data, an intersection point between the gaze-based selection ray and the controller-based selection ray;
based on the intersection point, identify a desired candidate object from the first set of two or more candidate objects or the second set of two or more candidate objects; and
cause a selection of the candidate object.

2. The non-transitory computer readable storage medium of claim 1, wherein the gaze-based selection ray is a combined selection ray that is based on first gaze of a first eye of the user and second gaze of a second eye of the user.

3. The non-transitory computer readable storage medium of claim 1, wherein identifying the desired candidate object from the first set of two or more candidate objects or the second set of two or more candidate objects occurs without display of an object selection cursor.

4. The non-transitory computer readable storage medium of claim 1, wherein each object of the plurality of virtual objects is presented with the extended-reality user interface at a respective depth relative to the user, and the desired candidate object is at a greater depth than at least one candidate object of the first set of two or more candidate objects.

5. The non-transitory computer readable storage medium of claim 4, wherein the desired candidate object is at a greater depth than at least one candidate object of the second set of two or more candidate objects.

6. The non-transitory computer readable storage medium of claim 1, wherein the computing device is a head-mounted device configured to present the extended-reality user interface to the user.

7. The non-transitory computer readable storage medium of claim 1, wherein the computing device is an intermediary device.

8. A method for object selection in extended-reality environments, the method comprising:
while an extended-reality user interface is being presented to a user, the extended-reality user interface includes a plurality of virtual objects available for selection:
receiving first data indicating a gaze-based selection ray based on an eye gaze of the user, wherein the gaze-based selection ray passes through a first set of two or more candidate objects of the plurality of virtual objects;
receiving second data indicating a controller-based selection ray based on position and orientation of an input controller used by the user to interact with the extended-reality user interface, wherein the controller-based selection ray passes through a second set of two or more candidate objects of the plurality of virtual objects;
determining, based on the first data and the second data, an intersection point between the gaze-based selection ray and the controller-based selection ray;
based on the intersection point, identifying a desired candidate object from the first set of two or more candidate objects or the second set of two or more candidate objects; and
causing a selection of the candidate object.

9. The method of claim 8, wherein the gaze-based selection ray is a combined selection ray that is based on first gaze of a first eye of the user and second gaze of a second eye of the user.

10. The method of claim 8, wherein identifying the desired candidate object from the first set of two or more candidate objects or the second set of two or more candidate objects occurs without display of an object selection cursor.

11. The method of claim 8, wherein each object of the plurality of objects is presented with the extended-reality user interface at a respective depth relative to the user, and the desired candidate object is at a greater depth than at least one candidate object of the first set of two or more candidate objects.

12. The method of claim 11, wherein the desired candidate object is at a greater depth than at least one candidate object of the second set of two or more candidate objects.

13. The method of claim 8, wherein the extended-reality user interface is being presented at a head-mounted device configured to present the extended-reality user interface to the user.

14. An electronic device, comprising:
one or more programs, wherein the one or more programs are stored in memory and configured to be executed by one or more processors, the one or more programs including instructions for:
while an extended-reality user interface is being presented to a user, the extended-reality user interface includes a plurality of virtual objects available for selection:
receiving first data indicating a gaze-based selection ray based on an eye gaze of the user, wherein the gaze-based selection ray passes through a first set of two or more candidate objects of the plurality of virtual objects;
receiving second data indicating a controller-based selection ray based on position and orientation of an input controller used by the user to interact with the extended-reality user interface, wherein the controller-based selection ray passes through a second set of two or more candidate objects of the plurality of virtual objects;
determining, based on the first data and the second data, an intersection point between the gaze-based selection ray and the controller-based selection ray;
based on the intersection point, identifying a desired candidate object from the first set of two or more candidate objects or the second set of two or more candidate objects; and
causing a selection of the candidate object.

15. The electronic device of claim 14, wherein the gaze-based selection ray is a combined selection ray that is based on first gaze of a first eye of the user and second gaze of a second eye of the user.

16. The electronic device of claim 14, wherein identifying the desired candidate object from the first set of two or more candidate objects or the second set of two or more candidate objects occurs without display of an object selection cursor.

17. The electronic device of claim 14, wherein each object of the plurality of objects is presented with the extended-reality user interface at a respective depth relative to the user, and the desired candidate object is at a greater depth than at least one candidate object of the first set of two or more candidate objects.

18. The electronic device of claim 17, wherein the desired candidate object is at a greater depth than at least one candidate object of the second set of two or more candidate objects.

19. The electronic device of claim 14, wherein the electronic device is a head-mounted device configured to present the extended-reality user interface to the user.

20. The electronic device of claim 14, wherein the electronic device is an intermediary device.
